(19) United States
(12) Patent Application Publication
(10) Pub. No.: US 2026/0214275 A1
(43) Pub. Date: Jul. 23, 2026

(54) METHOD FOR REDUCING SIGNALING OVERHEAD IN VIDEO CODING

(71) Applicant: MEDIATEK INC., Hsinchu City (TW)

(72) Inventors: Yi-Wen CHEN, San Jose, CA (US); Ching-Yeh CHEN, Hsinchu City (TW); Olena CHUBACH, San Jose, CA (US); Chih-Wei HSU, Hsinchu City (TW); Tzu-Der CHUANG, Hsinchu City (TW)

(21) Appl. No.: 19/142,376

(22) PCT Filed: Dec. 27, 2023
(86) PCT No.: PCT/CN2023/142315

§ 371 Date: Jun. 23, 2025

Related U.S. Application Data
(60) Provisional application No. 63/477,235, filed on Dec. 27, 2022.

(51) Int. Cl. H04N 19/70

(52) U.S. Cl. CPC H04N 19/70

(57) ABSTRACT

A method for video decoding in a video decoder is provided. The method includes receiving a first syntax element from a VPS, an SPS, or a PPS in a bitstream, the first syntax element indicating whether a second syntax element is signaled in an SH or a PH of a current picture; in response to the first syntax element having a first value indicating that the second syntax element is not signaled, deriving a value of the second syntax element based on values of at least one of the first syntax element and one or more third syntax elements in an NAL unit header, the VPS, the SPS, the PPS, the SH, or the PH; and in response to the first syntax element having a second value indicating that the second syntax element is signaled, deriving the value of the second syntax element based on the signaled second syntax element.

### CROSS REFERENCE TO RELATED APPLICATIONS

This present application claims the benefit of provisional Application No. 63/477,235, filed on Dec. 27, 2022. The disclosure of the prior application is incorporated herein by reference in its entirety.

### TECHNICAL FIELD

The present disclosure relates generally to video coding. In particular, the disclosure relates to the signaling and parsing of high-level syntax elements in video encoding and decoding systems.

### BACKGROUND

As a part of the video coding standard, a high-level syntax (HLS) defines the syntax and semantics of the video coding bitstream at a higher level of abstraction. It provides a structured representation of the video data and instructions for decoding it.

The Versatile Video Coding (VVC) standard inherits most of its HLS design from the preceding Advanced Video Codec (AVC) and High-Efficiency Video Coding (HEVC) standards. In VVC, high-level syntax elements can be a Network Abstraction Layer (NAL) unit syntax (including an NAL unit header), decoding capability information (DCI), operating point information (OPI), a video parameter set (VPS), a sequence parameter set (SPS), a picture parameter set (PPS), an adaptation parameter set (APS), video usability information (VUI), supplemental enhancement information (SEI), an access unit delimiter (AUD), a picture header (PH), a slice header (SH), an end-of-sequence (EOS), an end-of-bitstream (EOB), etc. A CTU-level or lower-level coding tool syntax is not considered as an HLS.

### SUMMARY

Aspects of the disclosure provide a method for video decoding in a video decoder. The method includes: receiving a first syntax element from a video parameter set (VPS), a sequence parameter set (SPS), or a picture parameter set (PPS) in a bitstream, the first syntax element indicating whether a second syntax element is signaled in a slice header (SH) or a picture header (PH) of a current picture; in response to the first syntax element having a first value indicating that the second syntax element is not signaled in the SH or the PH, deriving a value of the second syntax element based on values of at least one of the first syntax element and one or more third syntax elements in a network abstraction layer (NAL) unit header, the VPS, the SPS, the PPS, the SH, or the PH; and in response to the first syntax element having a second value indicating that the second syntax element is signaled in the SH or the PH, deriving the value of the second syntax element based on the second syntax element signaled in the SH or PH.

Aspects of the disclosure provide a method for video encoding in a video encoder. The method includes: signaling a first syntax element in a video parameter set (VPS), a sequence parameter set (SPS), or a picture parameter set (PPS) in a bitstream, the first syntax element indicating whether a second syntax element is signaled in a slice header (SH) or a picture header (PH), or left for a decoder to derive based on values of at least one of the first syntax element and one or more third syntax elements in a network abstraction layer (NAL) unit header, the VPS, the SPS, the PPS, the SH, or the PH; in response to the first syntax element having a first value indicating that the second syntax element is left for the decoder to derive, avoiding signaling the second syntax element in the SH or the PH; and in response to the first syntax element having a second value indicating that the second syntax element is signaled in the SH or the PH, signaling the second syntax element in the SH or the PH.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an example of using an additional high-level syntax element (e.g., “dummy”) to indicate how a syntax element “ph_non_ref_pic_flag” in a picture header is derived, according to embodiments of the disclosure;

FIGS. 2A and 2B show examples of using at least one additional high-level syntax element (e.g., “dummy,” or “dummy1” plus “dummy2”) to indicate how a syntax element “ph_gdr_pic_flag” in a picture header is derived, according to embodiments of the disclosure;

FIG. 3 shows an example of using an additional high-level syntax element (e.g., “dummy”) to indicate how a syntax element “ph_intra_slice_allowed_flag” in a picture header is derived, according to embodiments of the disclosure;

FIG. 4 shows an example of using an additional high-level syntax element (e.g., “dummy”) to indicate how a syntax element “ph_pic_parameter_set_id” in a picture header is derived, according to embodiments of the disclosure;

FIG. 5 shows an example of using an additional high-level syntax element (e.g., “dummy”) to indicate how a syntax element “ph_pic_output_flag” in a picture header is derived, according to embodiments of the disclosure;

FIG. 6 shows an example of using an additional high-level syntax element (e.g., “dummy”) to indicate how a syntax element “ph_collocated_ref_idx” in a picture header is derived, according to embodiments of the disclosure;

FIG. 7 an example of using an additional high-level syntax element (e.g., “dummy”) to indicate how a syntax element “sh_collocated_ref_idx” in a slice header (or a picture header) is derived, according to embodiments of the disclosure;

FIG. 8 shows an example of using an additional high-level syntax element (e.g., “dummy”) to indicate how a syntax element “sh_slice_type” in a slice header (or a picture header) is derived, according to embodiments of the disclosure;

FIG. 9 shows an example of using an additional high-level syntax element (e.g., “dummy”) to indicate how a syntax element “sh_dep_quant_idc” in a slice header (or a picture header) is derived, according to embodiments of the disclosure;

FIG. 10 shows an example of using an additional high-level syntax element (e.g., dummy) to indicate how a syntax element “ph_inter_slice_allowed_flag” in a picture header is derived, according to embodiments of the disclosure;

FIG. 11 shows a syntax element parsing process 1100 according to embodiments of the disclosure;

FIG. 12 shows a syntax element signaling process 1200 according to embodiments of the disclosure; and

FIG. 13 shows a block diagram of a video encoder according to an embodiment of the disclosure; and

FIG. 14 shows a block diagram of a video encoder according to an embodiment of the disclosure.

### DETAILED DESCRIPTION OF EMBODIMENTS

The following disclosure provides different embodiments, or examples, for implementing different features of the provided subject matter. Specific examples of components and arrangements are described below to simplify the present disclosure. These are, of course, merely examples and are not intended to be limiting.

For example, the order of discussion of the different steps as described herein has been presented for the sake of clarity. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present disclosure can be embodied and viewed in many different ways.

Furthermore, as used herein, the words “a,” “an,” and the like generally carry a meaning of “one or more,” unless stated otherwise.

The Versatile Video Coding (VVC) standard has defined various flags (or syntax elements) to enable control over different aspects of video coding. However, in many common scenarios, these flags are not always necessary. Take the syntax element “ph_inter_slice_allowed_flag” in the picture header (PH) as an example; it indicates whether the picture associated with the PH allows inter-slice coding or not. Typically, when all of the slices within the picture are coded as B-slices or P-slices, this flag is consistently set to 1. Conversely, when there are intra-coded slices (I-slices) in the picture, the flag is set to 0. As the majority of pictures do not contain inter-slices, signaling this flag for each picture becomes redundant in such scenarios.

To enhance coding efficiency, a syntax element, named “dummy,” can be introduced at a higher level (e.g., at the sequence level). When the syntax element “dummy” turns ON, the encoder does not signal the flag “ph_inter_slice_allowed_flag,” and the decoder is informed to derive or infer its value, instead of explicitly receiving it. This approach optimizes bit usage by avoiding the need to signal and parse the flag for each picture in the picture sequence.

According to embodiments of this disclosure, one or more additional high-level syntax elements can be designed to avoid signaling certain syntax elements in the slice header (SH) and/or the picture header, thereby reducing the number of bits used for the signaling. These high-level syntax element(s) can be signaled in the video parameter set (VPS), the sequence parameter set (SPS), and/or the picture parameter set (PPS), indicating whether a corresponding syntax element in the SH or PH is signaled or not.

When the corresponding syntax element in the SH or PH is signaled, its value can be derived based on the signaled value in the SH or PH. On the other hand, when the corresponding syntax element in the SH or PH is not signaled, its value can be derived based on the semantic values of the signaled one or more additional syntax elements and/or one or more other syntax elements signaled in the network abstraction layer (NAL) unit header, the VPS, the SPS, the PPS, the SH and/or the PH.

The concepts of this disclosure are further described below through several examples for implementation.

### Example 1

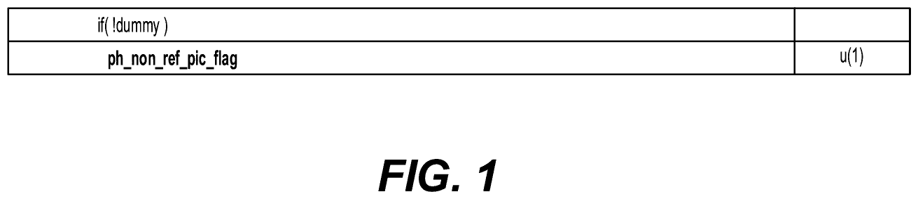

FIG. 1 shows an example of using an additional high-level syntax element (e.g., “dummy,” which can be freely changed to any other names without affecting its functionality) to indicate how a syntax element ph_non_ref_pic_flag in a picture header is derived, according to embodiments of the disclosure.

For example, the syntax element dummy can be signaled in the VPS, the SPS, and/or the PPS, thereby indicating whether the syntax element ph_non_ref_pic_flag is signaled in the associated picture header or not. When the dummy is signaled as its first value (e.g., 1), it indicates that the syntax element ph_non_ref_pic_flag is not signaled, and the value thereof can be inferred as a value specifying that the current picture may or may not be used as a reference picture. When the dummy is signaled as its second value (e.g., 0) that is different from the first value, the syntax element ph_non_ref_pic_flag is signaled in the PH according to the existing scheme, and its value is directly determined based on the signaled ph_non_ref_pic_flag. An example of the signaling of the syntax element ph_non_ref_pic_flag is illustrated in FIG. 1.

For instance, a value of ph_non_ref_pic_flag equal to 1 specifies that the current picture is never used as a reference picture. Conversely, a value of ph_non_ref_pic_flag equal to 0 specifies that the current picture may or may not be used as a reference picture. When the syntax element ph_non_ref_pic_flag is not signaled (i.e., when the dummy is equal to its first value), the value of ph_non_ref_pic_flag is inferred to be equal to 0.

### Example 2

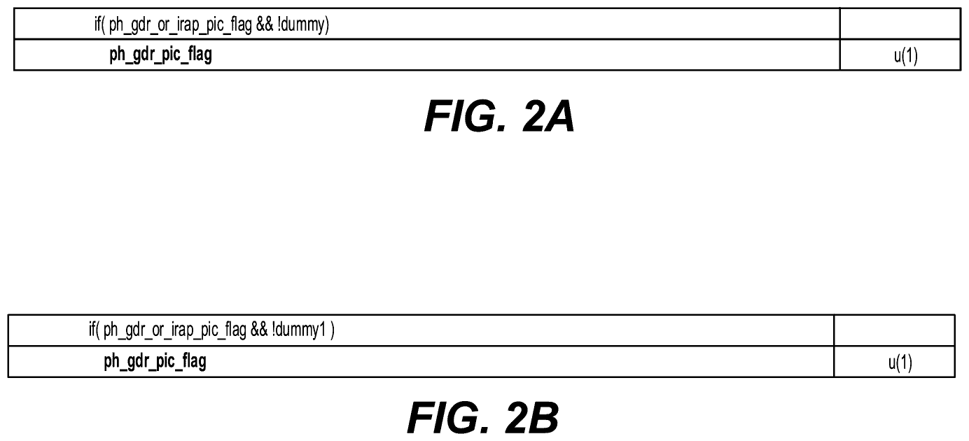

FIGS. 2A and 2B show examples of using at least one additional high-level syntax element (e.g., “dummy,” or “dummy1” plus “dummy2,” which can be freely changed to any other names without affecting their functionality) to indicate how a syntax element ph_gdr_pic_flag in a picture header is derived, according to embodiments of the disclosure.

For example, the syntax element dummy can be signaled in the VPS, the SPS, and/or the PPS, thereby indicating whether the syntax element ph_gdr_pic_flag is signaled in the associated picture header or not. When the dummy is signaled as its first value (e.g., 1), it indicates that the flag ph_gdr_pic_flag is not signaled and the value thereof is inferred as a value specifying that the current picture is not a gradual decoding refresh (GDR) picture. When the dummy is signaled as its second value (e.g., 0) that is different from the first value, the flag ph_gdr_pic_flag is signaled in the PH according to the existing scheme and its value is directly determined based on the signaled 20 ph_gdr_pic_flag. An example of the signaling of the syntax element ph_gdr_pic_flag and its semantic is illustrated in FIG. 2A.

For instance, a value of ph_gdr_pic_flag equal to 1 specifies that the current picture is a GDR picture. Conversely, a value of ph_gdr_pic_flag equal to 0 specifies that the current picture is not a GDR picture. When the syntax element sps_gdr_enabled_flag is equal to 0, the value of ph_gdr_pic_flag shall be equal to 0. When ph_gdr_pic_flag is not signaled (i.e., when the dummy is equal to its first value), the value of ph_gdr_pic_flag is inferred to be equal to 0. Note that when the syntax element ph_gdr_or_irap_pic_flag is equal to 1 and the syntax element ph_gdr_pic_flag is equal to 0, the current picture is an intra random access point (IRAP) picture.

Alternatively, one syntax element dummy1 can be signaled in the VPS, the SPS, and/or the PPS to indicate whether the syntax element ph_gdr_pic_flag is signaled in the associated picture header, and another syntax element dummy2 can be signaled in the VPS, the SPS, and/or the PPS to indicate the value of ph_gdr_pic_flag. When the dummy1 is signaled as its first value (e.g., 1), it indicates that the flag ph_gdr_pic_flag is not signaled and the value thereof is inferred as the value of the dummy2. When the dummy1 is signaled as its second value (e.g., 0) that is different from the first value, the flag ph_gdr_pic_flag is signaled in the PH according to the existing scheme and its value is directly determined based on the signaled ph_gdr_pic_flag. An example of the signaling of the syntax element ph_gdr_pic_flag is illustrated in FIG. 2B.

Again, a value of ph_gdr_pic_flag equal to 1 specifies that the current picture is a GDR picture. Conversely, a value of ph_gdr_pic_flag equal to 0 specifies that the current picture is not a GDR picture. When the syntax element sps_gdr_enabled_flag is equal to 0, the value of ph_gdr_pic_flag shall be equal to 0. When ph_gdr_pic_flag is not signaled (i.e., when the dummy 1 is equal to its first value), the value of ph_gdr_pic_flag is inferred to be equal to the value of the dummy2. When the syntax element ph_gdr_or_irap_pic_flag is equal to 1 and the syntax element ph_gdr_pic_flag is equal to 0, the current picture is an IRAP picture.

### Example 3

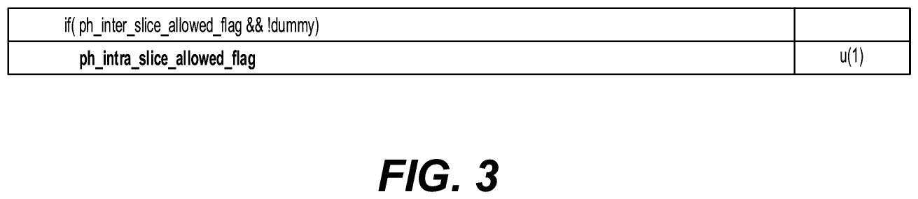

FIG. 3 shows an example of using an additional high-level syntax element (e.g., “dummy,” which can be freely changed to any other names without affecting its functionality) to indicate how a syntax element “ph_intra_slice_allowed_flag” in a picture header is derived, according to embodiments of the disclosure.

For example, the syntax element dummy can be signaled in the VPS, the SPS, and/or the PPS, thereby indicating whether the syntax element ph_intra_slice_allowed_flag is signaled in the associated picture header or not. When the dummy is signaled as its first value (e.g., 1), it indicates that the syntax element ph_intra_slice_allowed_flag is not signaled and the value thereof is inferred a value specifying that there may or may not be one or more coded slices in the current picture that are I slices. When the dummy is signaled as its second value (e.g., 0) that is different from the first value, the syntax element ph_intra_slice_allowed_flag is signaled in the PH according to the existing scheme, and its value is directly determined based on the signaled ph_intra_slice_allowed_flag. An example of the signaling of the syntax element ph_intra_slice_allowed_flag is illustrated in FIG. 3.

For instance, a value of ph_intra_slice_allowed_flag equal to 0 specifies that all coded slices of the current picture are B slices or P slices (corresponding to sh_slice_type values equal to 0 or 1, for example). Conversely, a value of ph_intra_slice_allowed_flag equal to 1 specifies that there may or may not be one or more coded slices in the current picture that are I slices (corresponding to a sh_slice_type value equal to 2). When ph_intra_slice_allowed_flag is not signaled (i.e., when the dummy is equal to its first value), the value of ph_intra_slice_allowed_flag is inferred to be equal to 1.

Note that for bitstreams that are supposed to work for subpicture based bitstream merging without the need of changing PH NAL units, the encoder is expected to set the values of both ph_inter_slice_allowed_flag and ph_intra_slice_allowed_flag equal to 1.

### Example 4

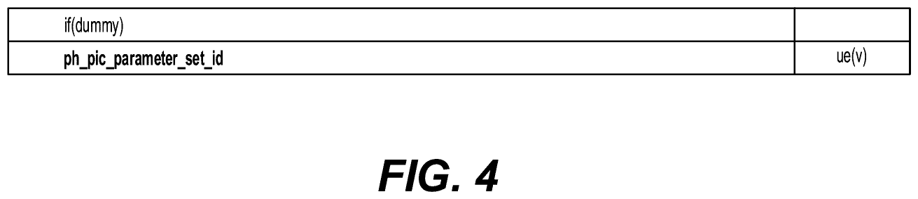

FIG. 4 shows an example of using an additional high-level syntax element (e.g., “dummy,” which can be freely changed to any other names without affecting its functionality) to indicate how a syntax element “ph_pic_parameter_set_id” in a picture header is derived, according to embodiments of the disclosure.

For example, the syntax element dummy can be signaled in the VPS, the SPS, and/or the PPS, thereby indicating whether the syntax element ph_pic_parameter_set_id is signaled in the associated picture header or not. When the dummy is signaled as its first value (e.g., 1), it indicates that the syntax element ph_pic_parameter_set_id is not signaled and the value thereof is inferred as 0, which specifies that the current picture is associated with a picture parameter set with an ID equal to 0. When the dummy is signaled as its second value (e.g., 0), the syntax element ph_pic_parameter_set_id is signaled in the PH according to the existing scheme, and its value is directly determined based on the signaled ph_pic_parameter_set_id. An example of the signaling of the syntax element ph_pic_parameter_set_id is illustrated in FIG. 4.

For instance, the value of ph_pic_parameter_set_id specifies the value of pps_pic_parameter_set_id for the picture parameter set in use. The value of ph_pic_parameter_set_id shall be in the range of 0 to 63, inclusive. When the syntax element ph_pic_parameter_set_id is not signaled (i.e., when the dummy is equal to its first value), the value of ph_pic_parameter_set_id is inferred to be equal to 0.

Note that it is a requirement of bitstream conformance that the value of TemporalId of the PH shall be greater than or equal to the value of TemporalId of the PPS that has pps_pic_parameter_set_id equal to ph_pic_parameter_set_id.

### Example 5

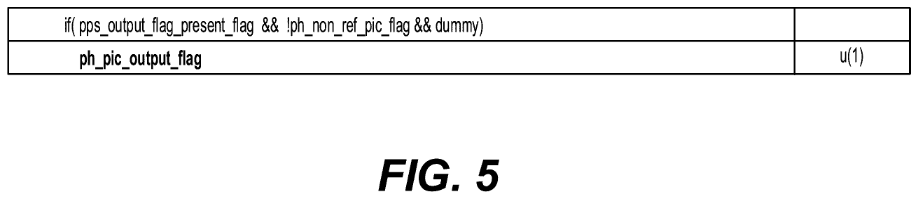

FIG. 5 shows an example of using an additional high-level syntax element (e.g., “dummy,” which can be freely changed to any other names without affecting its functionality) to indicate how a syntax element “ph_pic_output_flag” in a picture header is derived, according to embodiments of the disclosure.

For example, the syntax element dummy can be signaled in the VPS, the SPS, and/or the PPS, thereby indicating whether the syntax element ph_pic_output_flag is signaled in the associated picture header or not. When the dummy is signaled as its first value (e.g., 1), it indicates that the syntax element ph_pic_output_flag is not signaled and the value thereof is inferred as a value specifying that the current picture is in an output layer. When the dummy is signaled as its second value (e.g., 0) that is different from the first value, the syntax element ph_pic_output_flag is signaled in the PH according to the existing scheme, and its value is directly determined based on the signaled ph_pic_output_flag. An example of the signaling of the syntax element ph_pic_output_flag is illustrated in FIG. 5.

The value of ph_pic_output_flag affects the decoded picture output and removal processes as specified in Annex C of the H.266/VVC standard. When ph_pic_output_flag is not signaled (i.e., when the dummy is equal to its first value), the value of ph_pic_output_flag is inferred to be equal to 1.

Note that it is a requirement of bitstream conformance that the bitstream shall contain at least one picture with pic_output_flag equal to 1 that is in an output layer, and there is no picture in the bitsteam that has ph_non_ref_pic_flag equal to 1 and ph_pic_output_flag equal to 0.

### Example 6

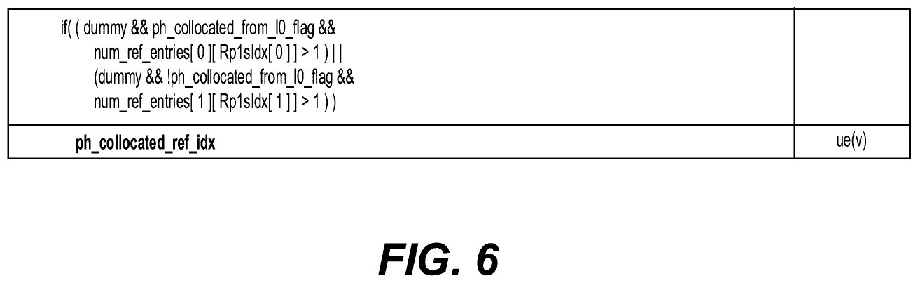

FIG. 6 shows an example of using an additional high-level syntax element (e.g., “dummy,” which can be freely changed to any other names without affecting its functionality) to indicate how a syntax element “ph_collocated_ref_idx” in a picture header is derived, according to embodiments of the disclosure.

For example, the syntax element dummy can be signaled in the VPS, the SPS, and/or the PPS, thereby indicating whether the syntax element ph_collocated_ref_idx is signaled in the associated picture header or not. When the dummy is signaled as its first value (e.g., 0), the syntax element ph_collocated_ref_idx is not signaled and the value thereof is inferred as 0, which specifies that the reference index of the collocated picture used for temporal motion vector prediction of the current picture is 0. When the dummy is signaled as its second value (e.g., 1) that is different from the first value, the syntax element ph_collocated_ref_idx is signaled in the PH according to the existing scheme, and its value is directly determined based on the signaled ph_collocated_ref_idx. An example of the signaling of the syntax element ph_collocated_ref_idx is illustrated in FIG. 6.

For instance, the value of ph_collocated_ref_idx specifies the reference index of the collocated picture used for temporal motion vector prediction. When ph_collocated_from_10_flag is equal to 1, ph_collocated_ref_idx refers to an entry in RPL 0, and the value of ph_collocated_ref_idx shall be in the range of 0 to num_ref_entries[0][RplsIdx[0]]−1, inclusive. When ph_collocated_from_10_flag is equal to 0, ph_collocated_ref_idx refers to an entry in RPL 1, and the value of ph_collocated_ref_idx shall be in the range of 0 to num_ref_entries[1][RplsIdx[1]]−1, inclusive. When ph_collocated_ref_idx is not signaled (i.e., when the dummy is equal to its first value), the value of ph_collocated_ref_idx is inferred to be equal to 0.

### Example 7

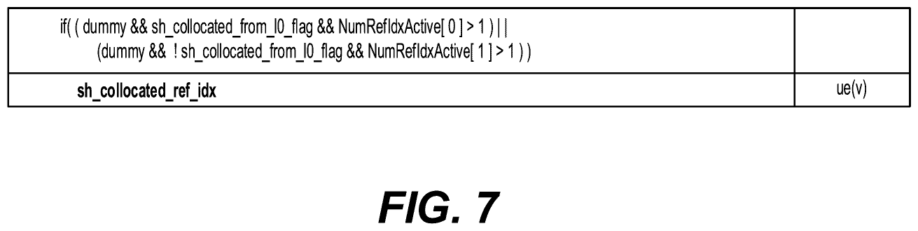

FIG. 7 an example of using an additional high-level syntax element (e.g., “dummy,” which can be freely changed to any other names without affecting its functionality) to indicate how a syntax element “sh_collocated_ref_idx” in a slice header (or in a picture header, if the picture is not divided into slices) is derived, according to embodiments of the disclosure.

For example, the syntax element dummy can be signaled in the VPS, the SPS, and/or the PPS, thereby indicating whether the syntax element sh_collocated_ref_idx is signaled in the associated SH (or the associated PH) or not. When the dummy is signaled as its first value (e.g., 0), the syntax element sh_collocated_ref_idx is not signaled and the value thereof is inferred as 0, which specifies that the reference index of the collocated picture used for temporal motion vector prediction of the current slice (or the current picture) is 0. When the dummy is signaled as its second value (e.g., 1) that is different from the first value, the syntax element sh_collocated_ref_idx is signaled in the SH (or the PH) according to the existing scheme, and its value is directly determined based on the signaled sh_collocated_ref_idx. An example of the signaling of the syntax element sh_collocated_ref_idx is illustrated in FIG. 7.

For instance, the value of sh_collocated_ref_idx specifies the reference index of the collocated picture used for temporal motion vector prediction. When sh_slice_type is equal to P or when sh_slice_type is equal to B and sh_collocated_from_10_flag is equal to 1, sh_collocated_ref_idx refers to an entry in RPL 0, and the value of sh_collocated_ref_idx shall be in the range of 0 to NumRefIdxActive[0]−1, inclusive. When sh_slice_type is equal to B and sh_collocated_from_10_flag is equal to 0, sh_collocated_ref_idx refers to an entry in RPL 1, and the value of sh_collocated_ref_idx shall be in the range of 0 to NumRefIdxActive[1]−1, inclusive. When sh_collocated_ref_idx is not present, the following applies:
If pps_rpl_info_in_ph_flag is equal to 1, the value of sh_collocated_ref_idx is inferred to be equal to ph_collocated_ref_idx.
Otherwise (pps_rpl_info_in_ph_flag is equal to 0), the value of sh_collocated_ref_idx is inferred to be equal to 0.

Let colPicList be set equal to sh_collocated_from_10_flag?0:1. It is a requirement of bitstream conformance that the picture referred to by sh_collocated_ref_idx shall be the same for all non-I slices of a coded picture, the value of RprConstraintsActiveFlag[colPicList][sh_collocated_ref_idx] shall be equal to 0, and the value of sps_log2_ctu_size_minus5 for the picture referred to by sh_collocated_ref_idx shall be equal to the value of sps_log2_ctu_size_minus5 for the current picture.

Note that the collocated picture has the same spatial resolution, the same scaling window offsets, the same number of subpictures, and the same CTU size as the current picture.

### Example 8

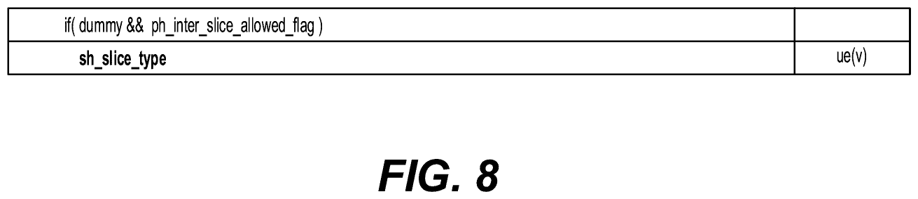

FIG. 8 shows an example of using an additional high-level syntax element (e.g., “dummy,” which can be freely changed to any other names without affecting its functionality) to indicate how a syntax element “sh_slice_type” in a slice header (or a picture header, if the picture is not divided into slices) is derived, according to embodiments of the disclosure;

For example, the syntax element dummy can be signaled in the VPS, the SPS, and/or the PPS, thereby indicating whether the syntax element sh_slice_type is signaled in the associated SH (or the associated PH) or not. When the dummy is signaled as its first value (e.g., 0), the syntax element sh_slice_type is not signaled and the value thereof is inferred as a value specifying that the current slice (or the current picture) is a B slice. Alternatively, the value of the syntax element sh_slice_type is inferred based on a value of another syntax element (e.g., “dummy2”) specifying whether an inter slice is allowed or not for coding the picture associated with the PH or the SH. When the dummy is signaled as its second value (e.g., 1) that is different from the first value, the syntax element sh_slice_type is signaled in the SH (or the PH) according to the existing scheme, and its value is directly determined based on the signaled sh_slice_type. An example of the signaling of the syntax element sh_slice_type is illustrated in FIG. 8.

For instance, the syntax element sh_slice_type can specify the coding type of the slice according to the table below.

TABLE
Name association to sh_slice_type

| sh_slice_type | Name of sh_slice_type |
|---|---|
| 0 | B (B slice) |
| 1 | P (P slice) |
| 2 | I (I slice) |

When not present, the value of sh_slice_type is inferred to be equal to 2.

When ph_intra_slice_allowed_flag is equal to 0, the value of sh_slice_type shall be equal to 0 or 1.

When both of the following conditions are true, the value of sh_slice_type shall be equal to 2:
The value of nal_unit_type is in the range of IDR_W_RADL to CRA_NUT, inclusive.
The value of vps_independent_layer_flag[GeneralLayerIdx[nuh_layer_id]] is equal to 1 or the current picture is the first picture in the current AU.

When sps_subpic_treated_as_pic_flag[CurrSubpicIdx] is equal to 0, pps_mixed_nalu_types_in_pic_flag is equal to 1 (i.e., there are at least two subpictures in the current picture having different NAL unit types), the value of sh_slice_type shall be equal to 2.

Note that this constraint is technically equivalent to the following: “When pps_mixed_nalu_types_in_pic_flag for a picture is equal to 1 (i.e., there are at least two subpictures in a picture having different NAL unit types), the value of sps_subpic_treated_as_pic_flag[ ] shall be equal to 1 for all the subpictures that are in the picture and contain at least one P or B slice.”

### Example 9

The coding efficiency of trellis-coded quantization (or termed as dependent quantization (DQ)) in VVC increases by increasing the number of quantization states, at the cost of a higher encoder complexity. Dependent quantization with 8 quantization states in addition to the current variant of dependent quantization with 4 quantization state is supported (see the JVET document JVET-Q0243). To support both variants of dependent quantization (4 and 8 states) in a unified framework, one syntax element, e.g., sh_dep_quant_idc, can be signaled in the SH and/or the PH to indicate whether 4-states dependent quantization or 8-states DQ is used for the current slice (or the current picture), or DQ is off for the current slice (or the current picture).

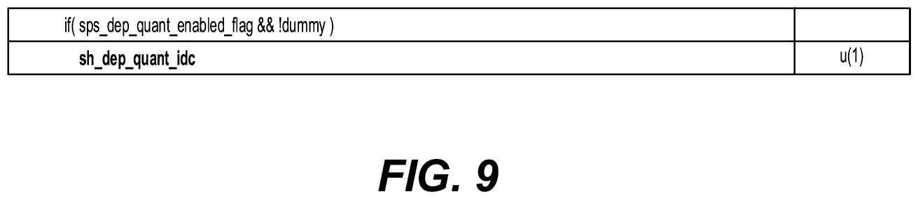

FIG. 9 shows an example of using an additional high-level syntax element (e.g., “dummy,” which can be freely changed to any other names without affecting its functionality) to indicate how the syntax element “sh_dep_quant_idc” in a slice header (or a picture header, if the picture is not divided into slices) is derived, according to embodiments of the disclosure.

For example, the syntax element dummy can be signaled in the VPS, the SPS, and/or the PPS, thereby indicating whether the syntax element sh_dep_quant_idc is signaled in the associated SH (or the associated PH) or not. When the dummy is signaled as its first value (e.g., 1), the syntax element sh_dep_quant_idc is not signaled and the value thereof is inferred as a value (e.g., 2 in ECM 6.0) for indicating the 8-state DQ. Alternatively, the value of the syntax element sh_dep_quant_idc is inferred as a value of another syntax element (e.g., “dummy2”) in the VPS, the SPS, or the PPS. When the dummy is signaled as its second value (e.g., 0) that is different from the first value, the syntax element sh_dep_quant_idc is signaled in the SH (or the PH) according to the existing scheme and its value is directly determined based on the signaled sh_dep_quant_idc. In some other embodiments, the first value of the dummy is 0 while the second value of the dummy of dummy is 1, which should not be limited in this disclosure. An example of the signaling of the syntax element sh_dep_quant_idc is illustrated in FIG. 9.

For instance, a value of sh_dep_quant_idc equal to 0 specifies that dependent quantization is not used for the current slice, while a value of sh_dep_quant_idc equal to 1 specifies that dependent quantization is used for the current slice. When sh_dep_quant_idc is not present, the following applies:
If dummy is equal to 1, the value of sh_dep_quant_idc is inferred to be equal to a value to indicate 8-states DQ (e.g., 2 in ECM 6.0).
Otherwise (dummy is equal to 0), the value of sh_dep_quant_idc is inferred to be equal to 0.

### Example 10

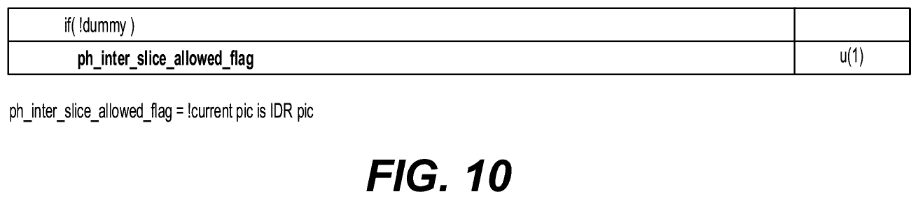

FIG. 10 shows an example of using an additional high-level syntax element (e.g., “dummy,” which can be freely changed to any other names without affecting its functionality) to indicate how a syntax element “ph_inter_slice_allowed_flag” in a picture header is derived, according to embodiments of the disclosure.

For example, the syntax element dummy can be signaled in the VPS, the SPS, and/or the PPS, thereby indicating whether the syntax element ph_inter_slice_allowed_flag is signaled in the associated picture header or not. When the dummy is signaled as its first value (e.g., 0), the syntax element ph_inter_slice_allowed_flag is not signaled and the value thereof is inferred depending on whether the current picture is an Instantaneous Decoder Refresh (IDR) picture or not. When dummy is signaled as its second value (e.g., 1) that is different from the first value, ph_inter_slice_allowed_flag is signaled in the PH according to the existing scheme, and its value is directly determined based on the signaled ph_inter_slice_allowed_flag. An example of the signaling of the syntax element ph_inter_slice_allowed_flag is illustrated in FIG. 10.

For instance, a value of ph_inter_slice_allowed_flag equal to 1 specifies there may or may not be one or more coded slices in the picture that are B slices or P slices. Conversely, a value of ph_inter_slice_allowed_flag equal to 0 specifies that all coded slices of the picture are I slices. When the syntax element ph_inter_slice_allowed_flag is not signaled (i.e., when the dummy is equal to its first value), the value of ph_inter_slice_allowed_flag is inferred depending on whether the current picture is an IDR picture. Specifically, if the current picture is an IDR picture, in the decoding process of which no inter prediction is used, the value of ph_inter_slice_allowed_flag is inferred to be equal to 0; if the current picture is not an IDR picture, the value of ph_inter_slice_allowed_flag is inferred to be equal to 1.

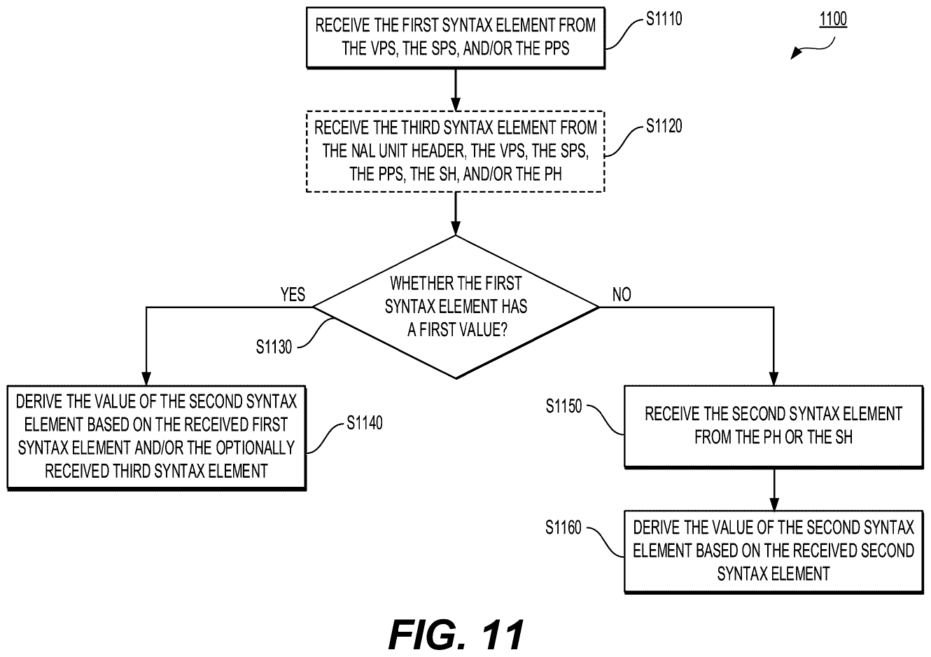

FIG. 11 shows a syntax element parsing process 1100 according to embodiments of the disclosure. In step S1110, a first syntax element is received from the VPS, the SPS, and/or the PPS. Optionally, in step S1120, a third syntax element is received from the NAL unit header, the VPS, the SPS, the PPS, the SH, and/or the PH. In step S1130, it is determined whether the received first syntax element has a first value. If the answer is “Yes,” in step S1140, the value of the second syntax element is derived based on the value of the first syntax element and/or the optionally received third syntax element. Otherwise, the second syntax element is received from the PH or the SH in step S1150, and in step S1160, the value of the second syntax element is derived based on the received second syntax element in the PH or the SH.

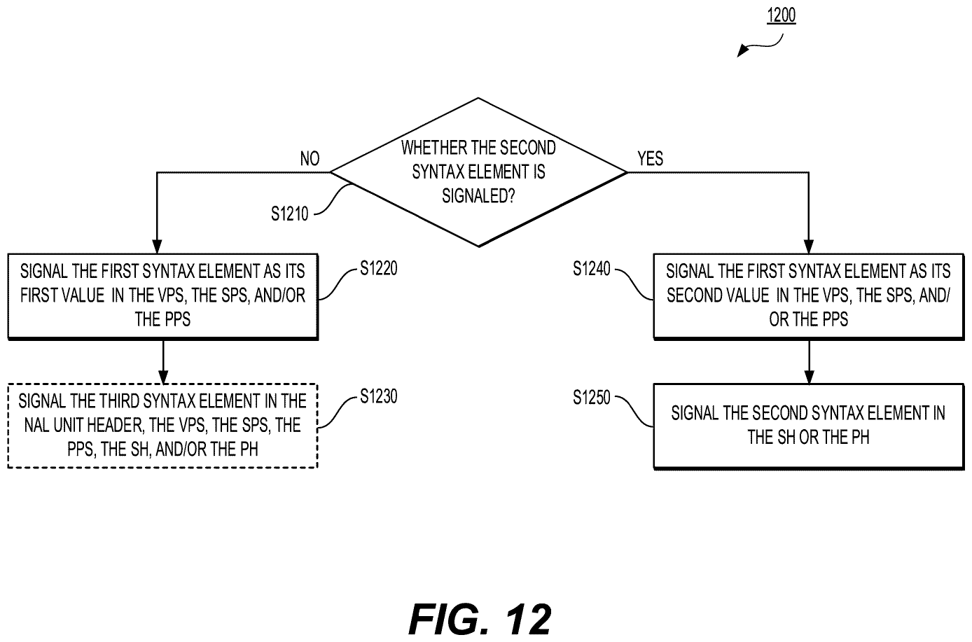

FIG. 12 shows a syntax element signaling process 1200 according to embodiments of the disclosure. In step S1210, it is determined whether the second syntax element is signaled in the PH (or the SH). If the answer is “No,” in step S1220, the first syntax element is signaled as its first value in the VPS, the SPS, and/or the PPS. Optionally, in step S1230, the third syntax element is signaled in the NAL unit header, the VPS, the SPS, the PPS, the SH, and/or the PH. If the answer in step S1210 is “Yes,” in step S1240, the first syntax element is signaled as its second value in the VPS, the SPS, and/or the PPS. In step 1250, the second syntax element is signaled in the PH (or the SH).

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

Aspects of the present disclosure are further described as follows.

### 1. High Level Syntax in VVC

In VVC, the high level syntax (HLS) specifically includes the NAL unit syntax (including the NAL unit header), decoding capability information (DCI), operating point information (OPI), video parameter set (VPS), sequence parameter set (SPS), picture parameter set (PPS), adaptation parameter set (APS), video usability information (VUI), supplemental enhancement information (SEI), access unit delimiter (AUD), picture header (PH), slice header (SH), end of sequence (EOS), end of bitstream (EOB), etc. CTU-level and lower-level coding tool syntax are not considered HLS. VVC inherited most of its HLS design from the preceding AVC and HEVC standards. Below gives illustration of the HLS in VVC at different levels.

A video parameter set (VPS), which contains details about layers and output layer sets (OLS), may be present in VVC bitstreams and be required for the decoding of scalable bitstreams based on OLS. The VPS of VVC is illustrated in Table 1 below.

TABLE 1

| | Descriptor |
|---|---|
| video_parameter_set_rbsp( ) { | |
| vps_video_parameter_set_id | u(4) |
| vps_max_layers_minus1 | u(6) |
| vps_max_sublayers_minus1 | u(3) |
| if( vps_max_layers_minus1 > 0 && vps_max_sublayers_minus1 > 0 ) | |
| vps_default_ptl_dpb_hrd_max_tid_flag | u(1) |
| if( vps_max_layers_minus1 > 0 ) | |
| vps_all_independent_layers_flag | u(1) |
| for( i = 0; i <= vps_max_layers_minus1; i++ ) { | |
| vps_layer_id[ i ] | u(6) |
| if( i > 0 && !vps_all_independent_layers_flag ) { | |
| vps_independent_layer_flag[ i ] | u(1) |
| if( !vps_independent_layer_flag[ i ] ) { | |
| vps_max_tid_ref_present_flag[ i ] | u(1) |
| for( j = 0; j < i; j++ ) { | |
| vps_direct_ref_layer_flag[ i ][ j ] | u(1) |
| if( vps_max_tid_ref_present_flag[ i ] && vps_direct_ref_layer_flag[ i ][ j ] ) | |
| vps_max_tid_il_ref_pics_plus1[ i ][ j ] | u(3) |
| } | |
| } | |
| } | |
| } | |
| if( vps_max_layers_minus1 > 0 ) { | |
| if( vps_all_independent_layers_flag ) | |
| vps_each_layer_is_an_ols_flag | u(1) |
| if( !vps_each_layer_is_an_ols_flag ) { | |
| if( !vps_all_independent_layers_flag ) | |
| vps_ols_mode_idc | u(2) |
| if( vps_ols_mode_idc = = 2 ) { | |
| vps_num_output_layer_sets_minus2 | u(8) |
| for( i = 1; i <= vps_num_output_layer_sets_minus2 + 1; i ++ ) | |
| for( j = 0; j <= vps_max_layers_minus1; j++ ) | |
| vps_ols_output_layer_flag[ i ][ j ] | u(1) |
| } | |
| } | |
| vps_num_ptls_minus1 | u(8) |
| } | |
| for( i = 0; i <= vps_num_ptls_minus1; i++ ) { | |
| if( i > 0 ) | |
| vps_pt_present_flag[ i ] | u(1) |
| if( !vps_default_ptl_dpb_hrd_max_tid_flag ) | |
| vps_ptl_max_tid[ i ] | u(3) |
| } | |
| while( !byte_aligned( ) ) | |
| vps_ptl_alignment_zero_bit /* equal to 0 */ | f(1) |
| for( i = 0; i <= vps_num_ptls_minus1; i++ ) | |
| profile_tier_level( vps_pt_present_flag[ i ], vps_ptl_max_tid[ i ] ) | |
| for( i = 0; i < TotalNumOlss; i++ ) | |
| if( vps_num_ptls_minus1 > 0 && vps_num_ptls_minus1 + 1 != TotalNumOlss ) | |
| vps_ols_ptl_idx[ i ] | u(8) |
| if( !vps_each_layer_is_an_ols_flag ) { | |
| vps_num_dpb_params_minus1 | ue(v) |
| if( vps_max_sublayers_minus1 > 0 ) | |
| vps_sublayer_dpb_params_present_flag | u(1) |
| for( i = 0; i < VpsNumDpbParams; i++ ) { | |
| if( !vps_default_ptl_dpb_hrd_max_tid_flag ) | |
| vps_dpb_max_tid[ i ] | u(3) |
| dpb_parameters( vps_dpb_max_tid[ i ], | |
| vps_sublayer_dpb_params_present_flag ) | |
| } | |
| for( i = 0; i < NumMultiLayerOlss; i++ ) { | |
| vps_ols_dpb_pic_width[ i ] | ue(v) |
| vps_ols_dpb_pic_height[ i ] | ue(v) |
| vps_ols_dpb_chroma_format[ i ] | u(2) |
| vps_ols_dpb_bitdepth_minus8[ i ] | ue(v) |
| if( VpsNumDpbParams > 1 && VpsNumDpbParams != NumMultiLayerOlss ) | |
| vps_ols_dpb_params_idx[ i ] | ue(v) |
| } | |
| vps_timing_hrd_params_present_flag | u(1) |
| if( vps_timing_hrd_params_present_flag ) { | |
| general_timing_hrd_parameters( ) | |
| if( vps_max_sublayers_minus1 > 0 ) | |
| vps_sublayer_cpb_params_present_flag | u(1) |
| vps_num_ols_timing_hrd_params_minus1 | ue(v) |
| for( i = 0; i <= vps_num_ols_timing_hrd_params_minus1; i++ ) { | |
| if( !vps_default_ptl_dpb_hrd_max_tid_flag ) | |
| vps_hrd_max_tid[ i ] | u(3) |
| firstSubLayer = vps_sublayer_cpb_params_present_flag ? 0 : vps_hrd_max_tid[ i ] | |
| ols_timing_hrd_parameters( firstSubLayer, vps_hrd_max_tid[ i ] ) | |
| } | |
| if( vps_num_ols_timing_hrd_params_minus1 > 0 && | |
| vps_num_ols_timing_hrd_params_minus1 + 1 != NumMultiLayerOlss ) | |
| for( i = 0; i < NumMultiLayerOlss; i++ ) | |
| vps_ols_timing_hrd_idx[ i ] | ue(v) |
| } | |
| } | |
| vps_extension_flag | u(1) |
| if( vps_extension_flag ) | |
| while( more_rbsp_data( ) ) | |
| vps_extension_data_flag | u(1) |
| rbsp_trailing_bits( ) | |
| } | |

The SPS conveys sequence-level information shared by all pictures in an entire CLVS. This includes profile, tier, and level (PTL) indicators, picture format (the color sampling format, maximum picture width, maximum picture height, and bit depth), feature/tool control flags, coding/prediction/transform block structures and hierarchies, candidate RPLs that may be referenced by the encoder, etc. In most applications, there would be only one or a few SPSs for an entire bitstream, and thus there would be no need to update an SPS (i.e., to send a new SPS using the SPS ID of an existing SPS but with different values for certain parameters) within the bitstream. Pictures from a particular layer that refer to SPSs with different SPS IDs or with the same SPS ID but with different SPS content belong to different CLVSs. As in AVC and HEVC, SPSs can be transported in-band (i.e., transported together with the coded pictures), out-of-band (i.e., not transported together with the coded pictures), or using a mixture of in-band and out-of-band signaling. The SPS of VVC is illustrated in Table 2 below.

TABLE 2

| | Descriptor |
|---|---|
| seq_parameter_set_rbsp( ) { | |
| sps_seq_parameter_set_id | u(4) |
| sps_video_parameter_set_id | u(4) |
| sps_max_sublayers_minus1 | u(3) |
| sps_chroma_format_idc | u(2) |
| sps_log2_ctu_size_minus5 | u(2) |
| sps_ptl_dpb_hrd_params_present_flag | u(1) |
| if( sps_ptl_dpb_hrd_params_present_flag ) | |
| profile_tier_level( 1, sps_max_sublayers_minus1 ) | |
| sps_gdr_enabled_flag | u(1) |
| sps_ref_pic_resampling_enabled_flag | u(1) |
| if( sps_ref_pic_resampling_enabled_flag ) | |
| sps_res_change_in_clvs_allowed_flag | u(1) |
| sps_pic_width_max_in_luma_samples | ue(v) |
| sps_pic_height_max_in_luma_samples | ue(v) |
| sps_conformance_window_flag | u(1) |
| if( sps_conformance_window_flag ) { | |
| sps_conf_win_left_offset | ue(v) |
| sps_conf_win_right_offset | ue(v) |
| sps_conf_win_top_offset | ue(v) |
| sps_conf_win_bottom_offset | ue(v) |
| } | |
| sps_subpic_info_present_flag | u(1) |
| if( sps_subpic_info_present_flag ) { | |
| sps_num_subpics_minus1 | ue(v) |
| if( sps_num_subpics_minus1 > 0 ) { | |
| sps_independent_subpics_flag | u(1) |
| sps_subpic_same_size_flag | u(1) |
| } | |
| for( i = 0; sps_num_subpics_minus1 > 0 && i <= sps_num_subpics_minus1; i++ ) { | |
| if( !sps_subpic_same_size_flag \| \| i = = 0 ) { | |
| if( i > 0 && sps_pic_width_max_in_luma_samples > CtbSizeY ) | |
| sps_subpic_ctu_top_left_x[ i ] | u(v) |
| if( i > 0 && sps_pic_height_max_in_luma_samples > CtbSizeY ) | |
| sps_subpic_ctu_top_left_y[ i ] | u(v) |
| if( i < sps_num_subpics_minus1 && | |
| sps_pic_width_max_in_luma_samples > CtbSizeY ) | |
| sps_subpic_width_minus1[ i ] | u(v) |
| if( i < sps_num_subpics_minus1 && | |
| sps_pic_height_max_in_luma_samples > CtbSizeY ) | |
| sps_subpic_height_minus1[ i ] | u(v) |
| } | |
| if( !sps_independent_subpics_flag) { | |
| sps_subpic_treated_as_pic_flag[ i ] | u(1) |
| sps_loop_filter_across_subpic_enabled_flag[ i ] | u(1) |
| } | |
| } | |
| sps_subpic_id_len_minus1 | ue(v) |
| sps_subpic_id_mapping_explicitly_signalled_flag | u(1) |
| if( sps_subpic_id_mapping_explicitly_signalled_flag ) { | |
| sps_subpic_id_mapping_present_flag | u(1) |
| if( sps_subpic_id_mapping_present_flag ) | |
| for( i = 0; i <= sps_num_subpics_minus1; i++ ) | |
| sps_subpic_id[ i ] | u(v) |
| } | |
| } | |
| sps_bitdepth_minus8 | ue(v) |
| sps_entropy_coding_sync_enabled_flag | u(1) |
| sps_entry_point_offsets_present_flag | u(1) |
| sps_log2_max_pic_order_cnt_lsb_minus4 | u(4) |
| sps_poc_msb_cycle_flag | u(1) |
| if( sps_poc_msb_cycle_flag ) | |
| sps_poc_msb_cycle_len_minus1 | ue(v) |
| sps_num_extra_ph_bytes | u(2) |
| for( i = 0; i < (sps_num_extra_ph_bytes * 8 ); i++ ) | |
| sps_extra_ph_bit_present_flag[ i ] | u(1) |
| sps_num_extra_sh_bytes | u(2) |
| for( i = 0; i < (sps_num_extra_sh_bytes * 8 ); i++ ) | |
| sps_extra_sh_bit_present_flag[ i ] | u(1) |
| if( sps_ptl_dpb_hrd_params_present_flag ) { | |
| if( sps_max_sublayers_minus1 > 0 ) | |
| sps_sublayer_dpb_params_flag | u(1) |
| dpb_parameters( sps_max_sublayers_minus1, sps_sublayer_dpb_params_flag ) | |
| } | |
| sps_log2_min_luma_coding_block_size_minus2 | ue(v) |
| sps_partition_constraints_override_enabled_flag | u(1) |
| sps_log2_diff_min_qt_min_cb_intra_slice_luma | ue(v) |
| sps_max_mtt_hierarchy_depth_intra_slice_luma | ue(v) |
| if( sps_max_mtt_hierarchy_depth_intra_slice_luma != 0 ) { | |
| sps_log2_diff_max_bt_min_qt_intra_slice_luma | ue(v) |
| sps_log2_diff_max_tt_min_qt_intra_slice_luma | ue(v) |
| } | |
| if( sps_chroma_format_idc != 0 ) | |
| sps_qtbtt_dual_tree_intra_flag | u(1) |
| if( sps_qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| sps_log2_diff_min_qt_min_cb_inter_slice | ue(v) |
| sps_max_mtt_hierarchy_depth_inter_slice | ue(v) |
| if( sps_max_mtt_hierarchy_depth_inter_slice != 0 ) { | |
| sps_log2_diff_max_bt_min_qt_inter_slice | ue(v) |
| sps_log2_diff_max_tt_min_qt_inter_slice | ue(v) |
| } | |
| if( CtbSizeY > 32 ) | |
| sps_max_luma_transform_size_64_flag | u(1) |
| sps_transform_skip_enabled_flag | u(1) |
| if( sps_transform_skip_enabled_flag ) { | |
| sps_log2_transform_skip_max_size_minus2 | ue(v) |
| sps_bdpcm_enabled_flag | u(1) |
| } | |
| sps_mts_enabled_flag | u(1) |
| if( sps_mts_enabled_flag ) { | |
| sps_explicit_mts_intra_enabled_flag | u(1) |
| sps_explicit_mts_inter_enabled_flag | u(1) |
| } | |
| sps_lfnst_enabled_flag | u(1) |
| if( sps_chroma_format_idc != 0 ) { | |
| sps_joint_cbcr_enabled_flag | u(1) |
| sps_same_qp_table_for_chroma_flag | u(1) |
| numQpTables = sps_same_qp_table_for_chroma_flag ? 1 : | |
| ( sps_joint_cbcr_enabled_flag ? 3 : 2 ) | |
| for( i = 0; i < numQpTables; i++ ) { | |
| sps_qp_table_start_minus26[ i ] | se(v) |
| sps_num_points_in_qp_table_minus1[ i ] | ue(v) |
| for( j = 0; j <= sps_num_points_in_qp_table_minus1[ i ]; j++ ) { | |
| sps_delta_qp_in_val_minus1[ i ][ j ] | ue(v) |
| sps_delta_qp_diff_val[ i ][ j ] | ue(v) |
| } | |
| } | |
| } | |
| sps_sao_enabled_flag | u(1) |
| sps_alf_enabled_flag | u(1) |
| if( sps_alf_enabled_flag && sps_chroma_format_idc != 0 ) | |
| sps_ccalf_enabled_flag | u(1) |
| sps_lmcs_enabled_flag | u(1) |
| sps_weighted_pred_flag | u(1) |
| sps_weighted_bipred_flag | u(1) |
| sps_long_term_ref_pics_flag | u(1) |
| if( sps_video_parameter_set_id > 0 ) | |
| sps_inter_layer_prediction_enabled_flag | u(1) |
| sps_idr_rpl_present_flag | u(1) |
| sps_rpl1_same_as_rpl0_flag | u(1) |
| for( i = 0; i < ( sps_rpl1_same_as_rpl0_flag ? 1 : 2 ); i++ ) { | |
| sps_num_ref_pic_lists[ i ] | ue(v) |
| for( j = 0; j < sps_num_ref_pic_lists[ i ]; j++) | |
| ref_pic_list_struct( i, j ) | |
| } | |
| sps_ref_wraparound_enabled_flag | u(1) |
| sps_temporal_mvp_enabled_flag | u(1) |
| if( sps_temporal_mvp_enabled_flag ) | |
| sps_sbtmvp_enabled_flag | u(1) |
| sps_amvr_enabled_flag | u(1) |
| sps_bdof_enabled_flag | u(1) |
| if( sps_bdof_enabled_flag ) | |
| sps_bdof_control_present_in_ph_flag | u(1) |
| sps_smvd_enabled_flag | u(1) |
| sps_dmvr_enabled_flag | u(1) |
| if( sps_dmvr_enabled_flag) | |
| sps_dmvr_control_present_in_ph_flag | u(1) |
| sps_mmvd_enabled_flag | u(1) |
| if( sps_mmvd_enabled_flag ) | |
| sps_mmvd_fullpel_only_enabled_flag | u(1) |
| sps_six_minus_max_num_merge_cand | ue(v) |
| sps_sbt_enabled_flag | u(1) |
| sps_affine_enabled_flag | u(1) |
| if( sps_affine_enabled_flag ) { | |
| sps_five_minus_max_num_subblock_merge_cand | ue(v) |
| sps_6param_affine_enabled_flag | u(1) |
| if( sps_amvr_enabled_flag ) | |
| sps_affine_amvr_enabled_flag | u(1) |
| sps_affine_prof_enabled_flag | u(1) |
| if( sps_affine_prof_enabled_flag ) | |
| sps_prof_control_present_in_ph_flag | u(1) |
| } | |
| sps_bcw_enabled_flag | u(1) |
| sps_ciip_enabled_flag | u(1) |
| if( MaxNumMergeCand >= 2 ) { | |
| sps_gpm_enabled_flag | u(1) |
| if( sps_gpm_enabled_flag && MaxNumMergeCand >= 3 ) | |
| sps_max_num_merge_cand_minus_max_num_gpm_cand | ue(v) |
| } | |
| sps_log2_parallel_merge_level_minus2 | ue(v) |
| sps_isp_enabled_flag | u(1) |
| sps_mrl_enabled_flag | u(1) |
| sps_mip_enabled_flag | u(1) |
| if( sps_chroma_format_idc != 0 ) | |
| sps_cclm_enabled_flag | u(1) |
| if( sps_chroma_format_idc = = 1 ) { | |
| sps_chroma_horizontal_collocated_flag | u(1) |
| sps_chroma_vertical_collocated_flag | u(1) |
| } | |
| sps_palette_enabled_flag | u(1) |
| if( sps_chroma_format_idc = = 3 && !sps_max_luma_transform_size_64_flag ) | |
| sps_act_enabled_flag | u(1) |
| if( sps_transform_skip_enabled_flag \| \| sps_palette_enabled_flag ) | |
| sps_min_qp_prime_ts | ue(v) |
| sps_ibc_enabled_flag | u(1) |
| if( sps_ibc_enabled_flag ) | |
| sps_six_minus_max_num_ibc_merge_cand | ue(v) |
| sps_ladf_enabled_flag | u(1) |
| if( sps_ladf_enabled_flag ) { | |
| sps_num_ladf_intervals_minus2 | u(2) |
| sps_ladf_lowest_interval_qp_offset | se(v) |
| for( i = 0; i < sps_num_ladf_intervals_minus2 + 1; i++ ) { | |
| sps_ladf_qp_offset[ i ] | se(v) |
| sps_ladf_delta_threshold_minus1[ i ] | ue(v) |
| } | |
| } | |
| sps_explicit_scaling_list_enabled_flag | u(1) |
| if( sps_lfnst_enabled_flag && sps_explicit_scaling_list_enabled_flag ) | |
| sps_scaling_matrix_for_lfnst_disabled_flag | u(1) |
| if( sps_act_enabled_flag && sps_explicit_scaling_list_enabled_flag ) | |
| sps_scaling_matrix_for_alternative_colour_space_disabled_flag | u(1) |
| if( sps_scaling_matrix_for_alternative_colour_space_disabled_flag ) | |
| sps_scaling_matrix_designated_colour_space_flag | u(1) |
| sps_dep_quant_enabled_flag | u(1) |
| sps_sign_data_hiding_enabled_flag | u(1) |
| sps_virtual_boundaries_enabled_flag | u(1) |
| if( sps_virtual_boundaries_enabled_flag ) { | |
| sps_virtual_boundaries_present_flag | u(1) |
| if( sps_virtual_boundaries_present_flag ) { | |
| sps_num_ver_virtual_boundaries | ue(v) |
| for( i = 0; i < sps_num_ver_virtual_boundaries; i++ ) | |
| sps_virtual_boundary_pos_x_minus1[ i ] | ue(v) |
| sps_num_hor_virtual_boundaries | ue(v) |
| for( i = 0; i < sps_num_hor_virtual_boundaries; i++ ) | |
| sps_virtual_boundary_pos_y_minus1[ i ] | ue(v) |
| } | |
| } | |
| if( sps_ptl_dpb_hrd_params_present_flag ) { | |
| sps_timing_hrd_params_present_flag | u(1) |
| if( sps_timing_hrd_params_present_flag ) { | |
| general_timing_hrd_parameters( ) | |
| if( sps_max_sublayers_minus1 > 0 ) | |
| sps_sublayer_cpb_params_present_flag | u(1) |
| firstSubLayer = sps_sublayer_cpb_params_present_flag ? 0 : | |
| sps_max_sublayers_minus1 | |
| ols_timing_hrd_parameters( firstSubLayer, sps_max_sublayers_minus1 ) | |
| } | |
| } | |
| sps_field_seq_flag | u(1) |
| sps_vui_parameters_present_flag | u(1) |
| if( sps_vui_parameters_present_flag ) { | |
| sps_vui_payload_size_minus1 | ue(v) |
| while( !byte_aligned( ) ) | |
| sps_vui_alignment_zero_bit | f(1) |
| vui_payload( sps_vui_payload_size_minus1 + 1 ) | |
| } | |
| sps_extension_flag | u(1) |
| if( sps_extension_flag ) | |
| while( more_rbsp_data( ) ) | |
| sps_extension_data_flag | u(1) |
| rbsp_trailing_bits( ) | |
| } | |

The PPS transmits picture-level information that can be changed between different pictures and is shared by all of the picture's slices. This contains picture width and height, default RPL sizes, tile and slice settings, feature/tool on/off flags, etc. While it is possible for two consecutive pictures to refer to two different PPSs by design, which could result in the use of a large number of PPSs within a CLVS, in practice, it is anticipated that the number of PPSs for an entire bitstream will be low because the PPS is made to carry parameters that are likely to apply to multiple pictures and do not change frequently. Therefore, updating a PPS within a CLVS or even within a bitstream as a whole is often not necessary. For parameters that could apply to multiple pictures but are expected to change frequently from picture to picture, a new type of parameter set called an adaptation parameter set (APS). The PPS of VVC is illustrated in Table 3 below.

TABLE 3

| | Descriptor |
|---|---|
| pic_parameter_set_rbsp( ) { | |
| pps_pic_parameter_set_id | u(6) |
| pps_seq_parameter_set_id | u(4) |
| pps_mixed_nalu_types_in_pic_flag | u(1) |
| pps_pic_width_in_luma_samples | ue(v) |
| pps_pic_height_in_luma_samples | ue(v) |
| pps_conformance_window_flag | u(1) |
| if( pps_conformance_window_flag ) { | |
| pps_conf_win_left_offset | ue(v) |
| pps_conf_win_right_offset | ue(v) |
| pps_conf_win_top_offset | ue(v) |
| pps_conf_win_bottom_offset | ue(v) |
| } | |
| pps_scaling_window_explicit_signalling_flag | u(1) |
| if( pps_scaling_window_explicit_signalling_flag ) { | |
| pps_scaling_win_left_offset | se(v) |
| pps_scaling_win_right_offset | se(v) |
| pps_scaling_win_top_offset | se(v) |
| pps_scaling_win_bottom_offset | se(v) |
| } | |
| pps_output_flag_present_flag | u(1) |
| pps_no_pic_partition_flag | u(1) |
| pps_subpic_id_mapping_present_flag | u(1) |
| if( pps_subpic_id_mapping_present_flag ) { | |
| if( !pps_no_pic_partition_flag ) | |
| pps_num_subpics_minus1 | ue(v) |
| pps_subpic_id_len_minus1 | ue(v) |
| for( i = 0; i <= pps_num_subpics_minus1; i++ ) | |
| pps_subpic_id[ i ] | u(v) |
| } | |
| if( !pps_no_pic_partition_flag ) { | |
| pps_log2_ctu_size_minus5 | u(2) |
| pps_num_exp_tile_columns_minus1 | ue(v) |
| pps_num_exp_tile_rows_minus1 | ue(v) |
| for( i = 0; i <= pps_num_exp_tile_columns_minus1; i++ ) | |
| pps_tile_column_width_minus1[ i ] | ue(v) |
| for( i = 0; i <= pps_num_exp_tile_rows_minus1; i++ ) | |
| pps_tile_row_height_minus1[ i ] | ue(v) |
| if( NumTilesInPic > 1 ) { | |
| pps_loop_filter_across_tiles_enabled_flag | u(1) |
| pps_rect_slice_flag | u(1) |
| } | |
| if( pps_rect_slice_flag ) | |
| pps_single_slice_per_subpic_flag | u(1) |
| if( pps_rect_slice_flag && !pps_single_slice_per_subpic_flag ) { | |
| pps_num_slices_in_pic_minus1 | ue(v) |
| if( pps_num_slices_in_pic_minus1 > 1 ) | |
| pps_tile_idx_delta_present_flag | u(1) |
| for( i = 0; i < pps_num_slices_in_pic_minus1; i++ ) { | |
| if( SliceTopLeftTileIdx[ i ] % NumTileColumns != NumTileColumns − 1 ) | |
| pps_slice_width_in_tiles_minus1[ i ] | ue(v) |
| if( SliceTopLeftTileIdx[ i ] / NumTileColumns != NumTileRows − 1 && | |
| ( pps_tile_idx_delta_present_flag \| \| | |
| SliceTopLeftTileIdx[ i ] % NumTileColumns = = 0 ) ) | |
| pps_slice_height_in_tiles_minus1[ i ] | ue(v) |
| if( pps_slice_width_in_tiles_minus1[ i ] = = 0 && | |
| pps_slice_height_in_tiles_minus1[ i ] = = 0 && | |
| RowHeightVal[ SliceTopLeftTileIdx[ i ] / NumTileColumns ] > 1 ) { | |
| pps_num_exp_slices_in_tile[ i ] | ue(v) |
| for( j = 0; j < pps_num_exp_slices_in_tile[ i ]; j++ ) | |
| pps_exp_slice_height_in_ctus_minus1[ i ][ j ] | ue(v) |
| i += NumSlicesInTile[ i ] − 1 | |
| } | |
| if( pps_tile_idx_delta_present_flag && i < pps_num_slices_in_pic_minus1 ) | |
| pps_tile_idx_delta_val[ i ] | se(v) |
| } | |
| } | |
| if( !pps_rect_slice_flag \| \| pps_single_slice_per_subpic_flag \| \| | |
| pps_num_slices_in_pic_minus1 > 0 ) | |
| pps_loop_filter_across_slices_enabled_flag | u(1) |
| } | |
| pps_cabac_init_present_flag | u(1) |
| for(i = 0; i < 2; i++ ) | |
| pps_num_ref_idx_default_active_minus1[ i ] | ue(v) |
| pps_rpl1_idx_present_flag | u(1) |
| pps_weighted_pred_flag | u(1) |
| pps_weighted_bipred_flag | u(1) |
| pps_ref_wraparound_enabled_flag | u(1) |
| if( pps_ref_wraparound_enabled_flag ) | |
| pps_pic_width_minus_wraparound_offset | ue(v) |
| pps_init_qp_minus26 | se(v) |
| pps_cu_qp_delta_enabled_flag | u(1) |
| pps_chroma_tool_offsets_present_flag | u(1) |
| if( pps_chroma_tool_offsets_present_flag ) { | |
| pps_cb_qp_offset | se(v) |
| pps_cr_qp_offset | se(v) |
| pps_joint_cbcr_qp_offset_present_flag | u(1) |
| if( pps_joint_cbcr_qp_offset_present_flag ) | |
| pps_joint_cbcr_qp_offset_value | se(v) |
| pps_slice_chroma_qp_offsets_present_flag | u(1) |
| pps_cu_chroma_qp_offset_list_enabled_flag | u(1) |
| if( pps_cu_chroma_qp_offset_list_enabled_flag ) { | |
| pps_chroma_qp_offset_list_len_minus1 | ue(v) |
| for( i = 0; i <= pps_chroma_qp_offset_list_len_minus1; i++ ) { | |
| pps_cb_qp_offset_list[ i ] | se(v) |
| pps_cr_qp_offset_list[ i ] | se(v) |
| if( pps_joint_cbcr_qp_offset_present_flag ) | |
| pps_joint_cbcr_qp_offset_list[ i ] | se(v) |
| } | |
| } | |
| } | |
| pps_deblocking_filter_control_present_flag | u(1) |
| if( pps_deblocking_filter_control_present_flag ) { | |
| pps_deblocking_filter_override_enabled_flag | u(1) |
| pps_deblocking_filter_disabled_flag | u(1) |
| if( !pps_no_pic_partition_flag && | |
| pps_deblocking_filter_override_enabled_flag ) | |
| pps_dbf_info_in_ph_flag | u(1) |
| if( !pps_deblocking_filter_disabled_flag ) { | |
| pps_luma_beta_offset_div2 | se(v) |
| pps_luma_tc_offset_div2 | se(v) |
| if( pps_chroma_tool_offsets_present_flag ) { | |
| pps_cb_beta_offset_div2 | se(v) |
| pps_cb_tc_offset_div2 | se(v) |
| pps_cr_beta_offset_div2 | se(v) |
| pps_cr_tc_offset_div2 | se(v) |
| } | |
| } | |
| } | |
| if( !pps_no_pic_partition_flag ) { | |
| pps_rpl_info_in_ph_flag | u(1) |
| pps_sao_info_in_ph_flag | u(1) |
| pps_alf_info_in_ph_flag | u(1) |
| if( ( pps_weighted_pred_flag \| \| pps_weighted_bipred_flag ) && | |
| pps_rpl_info_in_ph_flag ) | |
| pps_wp_info_in_ph_flag | u(1) |
| pps_qp_delta_info_in_ph_flag | u(1) |
| } | |
| pps_picture_header_extension_present_flag | u(1) |
| pps_slice_header_extension_present_flag | u(1) |
| pps_extension_flag | u(1) |
| if( pps_extension_flag ) | |
| while( more_rbsp_data( ) ) | |
| pps_extension_data_flag | u(1) |
| rbsp_trailing_bits( ) | |
| } | |

Adaptation parameter sets (APSs) convey picture- and/or slice-level information that may be shared by multiple slices of a picture, and/or by slices of different pictures, but could change frequently from picture-to-picture and for which the total number of variants could be very high thus not suitable for inclusion into the PPS. Three types of parameters are included in APSs: adaptive loop filter (ALF) parameters, luma mapping with chroma scaling (LMCS) parameters, and quantization scaling list parameters. Depending on the type of data they carry, APSs can be carried in two distinct NAL unit types, either preceding or succeeding the associated slices as a prefix or suffix. Using suffix NAL units could be helpful for ALF parameters, since a typical way for an encoder to operate, especially in low-delay use cases, would be to use the statistics of the current picture to generate the ALF parameters to apply to subsequent pictures in decoding order. The APS of VVC is illustrated in the Table 4 below.

TABLE 4

| | Descriptor |
|---|---|
| adaptation_parameter_set_rbsp( ) { | |
| aps_params_type | u(3) |
| aps_adaptation_parameter_set_id | u(5) |
| aps_chroma_present_flag | u(1) |
| if( aps_params_type = = ALF_APS ) | |
| alf_data( ) | |
| else if( aps_params_type = = LMCS_APS ) | |
| lmcs_data( ) | |
| else if( aps_params_type = = SCALING_APS ) | |
| scaling_list_data( ) | |
| aps_extension_flag | u(1) |
| if( aps_extension_flag ) | |
| while( more_rbsp_data( ) ) | |
| aps_extension_data_flag | u(1) |
| rbsp_trailing_bits( ) | |
| } | |

AVC and HEVC did not employ the relatively straightforward concept of using a picture header (PH) because the PPS and SH were adequate to transmit picture-level information in those standards, although previous standards like MPEG-2 did use it. For each picture in VVC, there is a PH structure (shown in Table 5). A PH can be found either in a standalone PH NAL unit or as slice header syntax (SH). Only when the entire PU only comprises one slice may the PH be included in the SH. Within a CLVS, PHs can either be all in SHs or all in PH NAL units, which simplifies the design. The PH can only be included in the SH if the entire PU contains only one slice. The PH is designed for two objectives. The first is to help reduce the signaling overhead of SHs for pictures containing multiple slices per picture, by carrying syntax elements that have the same value for all slices of a picture, thus avoiding the repetition of these syntax elements in each SH and avoiding moving syntax into the PPS that might change frequently from picture to picture. These include IRAP/GDR picture indications, inter and intra slice type allowance flags, and information related to picture order count (POC), RPLs, deblocking filter, sample adaptive offset (SAO), ALF, LMCS, quantization scaling lists, quantization parameter (QP) delta, weighted prediction, coding block partitioning, virtual boundaries, identification of a picture for collocated picture prediction properties, etc. The second purpose is to help the decoder to identify the first slice of each coded picture that contains multiple slices. Since one and only one PH is present for each PU, when the decoder receives a PH NAL unit, it easily knows that the next VCL NAL unit is the first slice of a picture.

TABLE 5

| | Descriptor |
|---|---|
| picture_header_structure( ) { | |
| ph_gdr_or_irap_pic_flag | u(1) |
| ph_non_ref_pic_flag | u(1) |
| if( ph_gdr_or_irap_pic_flag ) | |
| ph_gdr_pic_flag | u(1) |
| ph_inter_slice_allowed_flag | u(1) |
| if( ph_inter_slice_allowed_flag ) | |
| ph_intra_slice_allowed_flag | u(1) |
| ph_pic_parameter_set_id | ue(v) |
| ph_pic_order_cnt_lsb | u(v) |
| if( ph_gdr_pic_flag ) | |
| ph_recovery_poc_cnt | ue(v) |
| for( i = 0; i < NumExtraPhBits; i++ ) | |
| ph_extra_bit[ i ] | u(1) |
| if( sps_poc_msb_cycle_flag ) { | |
| ph_poc_msb_cycle_present_flag | u(1) |
| if( ph_poc_msb_cycle_present_flag ) | |
| ph_poc_msb_cycle_val | u(v) |
| } | |
| if( sps_alf_enabled_flag && pps_alf_info_in_ph_flag ) { | |
| ph_alf_enabled_flag | u(1) |
| if( ph_alf_enabled_flag ) { | |
| ph_num_alf_aps_ids_luma | u(3) |
| for( i = 0; i < ph_num_alf_aps_ids_luma; i++ ) | |
| ph_alf_aps_id_luma[ i ] | u(3) |
| if( sps_chroma_format_idc != 0 ) { | |
| ph_alf_cb_enabled_flag | u(1) |
| ph_alf_cr_enabled_flag | u(1) |
| } | |
| if( ph_alf_cb_enabled_flag \| \| ph_alf_cr_enabled_flag ) | |
| ph_alf_aps_id_chroma | u(3) |
| if( sps_ccalf_enabled_flag ) { | |
| ph_alf_cc_cb_enabled_flag | u(1) |
| if( ph_alf_cc_cb_enabled_flag ) | |
| ph_alf_cc_cb_aps_id | u(3) |
| ph_alf_cc_cr_enabled_flag | u(1) |
| if( ph_alf_cc_cr_enabled_flag ) | |
| ph_alf_cc_cr_aps_id | u(3) |
| } | |
| } | |
| } | |
| if( sps_lmcs_enabled_flag ) { | |
| ph_lmcs_enabled_flag | u(1) |
| if( ph_lmcs_enabled_flag ) { | |
| ph_lmcs_aps_id | u(2) |
| if( sps_chroma_format_idc != 0 ) | |
| ph_chroma_residual_scale_flag | u(1) |
| } | |
| } | |
| if( sps_explicit_scaling_list_enabled_flag ) { | |
| ph_explicit_scaling_list_enabled_flag | u(1) |
| if( ph_explicit_scaling_list_enabled_flag ) | |
| ph_scaling_list_aps_id | u(3) |
| } | |
| if( sps_virtual_boundaries_enabled_flag && !sps_virtual_boundaries_present_flag ) { | |
| ph_virtual_boundaries_present_flag | u(1) |
| if( ph_virtual_boundaries_present_flag ) { | |
| ph_num_ver_virtual_boundaries | ue(v) |
| for( i = 0; i < ph_num_ver_virtual_boundaries; i++ ) | |
| ph_virtual_boundary_pos_x_minus1[ i ] | ue(v) |
| ph_num_hor_virtual_boundaries | ue(v) |
| for( i = 0; i < ph_num_hor_virtual_boundaries; i++ ) | |
| ph_virtual_boundary_pos_y_minus1[ i ] | ue(v) |
| } | |
| } | |
| if( pps_output_flag_present_flag && !ph_non_ref_pic_flag ) | |
| ph_pic_output_flag | u(1) |
| if( pps_rpl_info_in_ph_flag ) | |
| ref_pic_lists( ) | |
| if( sps_partition_constraints_override_enabled_flag ) | |
| ph_partition_constraints_override_flag | u(1) |
| if( ph_intra_slice_allowed_flag ) { | |
| if( ph_partition_constraints_override_flag ) { | |
| ph_log2_diff_min_qt_min_cb_intra_slice_luma | ue(v) |
| ph_max_mtt_hierarchy_depth_intra_slice_luma | ue(v) |
| if( ph_max_mtt_hierarchy_depth_intra_slice_luma != 0 ) { | |
| ph_log2_diff_max_bt_min_qt_intra_slice_luma | ue(v) |
| ph_log2_diff_max_tt_min_qt_intra_slice_luma | ue(v) |
| } | |
| if( sps_qtbtt_dual_tree_intra_flag ) { | |
| ph_log2_diff_min_qt_min_cb_intra_slice_chroma | ue(v) |
| ph_max_mtt_hierarchy_depth_intra_slice_chroma | ue(v) |
| if( ph_max_mtt_hierarchy_depth_intra_slice_chroma != 0 ) { | |
| ph_log2_diff_max_bt_min_qt_intra_slice_chroma | ue(v) |
| ph_log2_diff_max_tt_min_qt_intra_slice_chroma | ue(v) |
| } | |
| } | |
| } | |
| if( pps_cu_qp_delta_enabled_flag ) | |
| ph_cu_qp_delta_subdiv_intra_slice | ue(v) |
| if( pps_cu_chroma_qp_offset_list_enabled_flag ) | |
| ph_cu_chroma_qp_offset_subdiv_intra_slice | ue(v) |
| } | |
| if( ph_inter_slice_allowed_flag ) { | |
| if( ph_partition_constraints_override_flag ) { | |
| ph_log2_diff_min_qt_min_cb_inter_slice | ue(v) |
| ph_max_mtt_hierarchy_depth_inter_slice | ue(v) |
| if( ph_max_mtt_hierarchy_depth_inter_slice != 0 ) { | |
| ph_log2_diff_max_bt_min_qt_inter_slice | ue(v) |
| ph_log2_diff_max_tt_min_qt_inter_slice | ue(v) |
| } | |
| } | |
| if( pps_cu_qp_delta_enabled_flag ) | |
| ph_cu_qp_delta_subdiv_inter_slice | ue(v) |
| if( pps_cu_chroma_qp_offset_list_enabled_flag ) | |
| ph_cu_chroma_qp_offset_subdiv_inter_slice | ue(v) |
| if( sps_temporal_mvp_enabled_flag ) { | |
| ph_temporal_mvp_enabled_flag | u(1) |
| if( ph_temporal_mvp_enabled_flag && pps_rpl_info_in_ph_flag ) { | |
| if( num_ref_entries[ 1 ][ RplsIdx[ 1 ] ] > 0 ) | |
| ph_collocated_from_l0_flag | u(1) |
| if( ( ph_collocated_from_l0_flag && | |
| num_ref_entries[ 0 ][ RplsIdx[ 0 ] ] > 1 ) \| \| | |
| ( !ph_collocated_from_l0_flag && | |
| num_ref_entries[ 1 ][ RplsIdx[ 1 ] ] > 1 ) ) | |
| ph_collocated_ref_idx | ue(v) |
| } | |
| } | |
| if( sps_mmvd_fullpel_only_enabled_flag ) | |
| ph_mmvd_fullpel_only_flag | u(1) |
| presenceFlag = 0 | |
| if( !pps_rpl_info_in_ph_flag ) /* This condition is intentionally not merged into the next, | |
| to avoid possible interpretation of RplsIdx[ i ] not having a specified value. */ | |
| presenceFlag = 1 | |
| else if( num_ref_entries[ 1 ][ RplsIdx[ 1 ] ] > 0 ) | |
| presenceFlag = 1 | |
| if( presenceFlag ) { | |
| ph_mvd_l1_zero_flag | u(1) |
| if( sps_bdof_control_present_in_ph_flag ) | |
| ph_bdof_disabled_flag | u(1) |
| if( sps_dmvr_control_present_in_ph_flag ) | |
| ph_dmvr_disabled_flag | u(1) |
| } | |
| if( sps_prof_control_present_in_ph_flag ) | |
| ph_prof_disabled_flag | u(1) |
| if( ( pps_weighted_pred_flag \| \| pps_weighted_bipred_flag ) && | |
| pps_wp_info_in_ph_flag ) | |
| pred_weight_table( ) | |
| } | |
| if( pps_qp_delta_info_in_ph_flag ) | |
| ph_qp_delta | se(v) |
| if( sps_joint_cbcr_enabled_flag ) | |
| ph_joint_cbcr_sign_flag | u(1) |
| if( sps_sao_enabled_flag && pps_sao_info_in_ph_flag ) { | |
| ph_sao_luma_enabled_flag | u(1) |
| if( sps_chroma_format_idc != 0 ) | |
| ph_sao_chroma_enabled_flag | u(1) |
| } | |
| if( pps_dbf_info_in_ph_flag ) { | |
| ph_deblocking_params_present_flag | u(1) |
| if( ph_deblocking_params_present_flag ) { | |
| if( !pps_deblocking_filter_disabled_flag ) | |
| ph_deblocking_filter_disabled_flag | u(1) |
| if( !ph_deblocking_filter_disabled_flag ) { | |
| ph_luma_beta_offset_div2 | se(v) |
| ph_luma_tc_offset_div2 | se(v) |
| if( pps_chroma_tool_offsets_present_flag ) { | |
| ph_cb_beta_offset_div2 | se(v) |
| ph_cb_tc_offset_div2 | se(v) |
| ph_cr_beta_offset_div2 | se(v) |
| ph_cr_tc_offset_div2 | se(v) |
| } | |
| } | |
| } | |
| } | |
| if( pps_picture_header_extension_present_flag ) { | |
| ph_extension_length | ue(v) |
| for( i = 0; i < ph_extension_length; i++) | |
| ph_extension_data_byte[ i ] | u(8) |
| } | |
| } | |

The slice header (SH) transmits data for a certain slice, which is the collection of CTUs in a picture that are transmitted in a specific scanning sequence within a single VCL NAL unit. The VVC's SH was created with the intention of communicating knowledge that is specific to the slice and might be different for other slices of the same picture. The SH of VVC is illustrated in Table 6 below.

TABLE 6

| | Descriptor |
|---|---|
| slice_header( ) { | |
| sh_picture_header_in_slice_header_flag | u(1) |
| if( sh_picture_header_in_slice_header_flag ) | |
| picture_header_structure( ) | |
| if( sps_subpic_info_present_flag ) | |
| sh_subpic_id | u(v) |
| if( ( pps_rect_slice_flag && NumSlicesInSubpic[ CurrSubpicIdx ] > 1 ) \| \| | |
| ( !pps_rect_slice_flag && NumTilesInPic > 1 ) ) | |
| sh_slice_address | u(v) |
| for( i = 0; i < NumExtraShBits; i++ ) | |
| sh_extra_bit[ i ] | u(1) |
| if( !pps_rect_slice_flag && NumTilesInPic − sh_slice_address > 1 ) | |
| sh_num_tiles_in_slice_minus1 | ue(v) |
| if( ph_inter_slice_allowed_flag ) | |
| sh_slice_type | ue(v) |
| if( nal_unit_type = = IDR_W_RADL \| \| nal_unit_type = = IDR_N_LP \| \| | |
| nal_unit_type = = CRA_NUT \| \| nal_unit_type = = GDR_NUT ) | |
| sh_no_output_of_prior_pics_flag | u(1) |
| if( sps_alf_enabled_flag && !pps_alf_info_in_ph_flag ) { | |
| sh_alf_enabled_flag | u(1) |
| if( sh_alf_enabled_flag ) { | |
| sh_num_alf_aps_ids_luma | u(3) |
| for( i = 0; i < sh_num_alf_aps_ids_luma; i++ ) | |
| sh_alf_aps_id_luma[ i ] | u(3) |
| if( sps_chroma_format_idc != 0 ) { | |
| sh_alf_cb_enabled_flag | u(1) |
| sh_alf_cr_enabled_flag | u(1) |
| } | |
| if( sh_alf_cb_enabled_flag \| \| sh_alf_cr_enabled_flag ) | |
| sh_alf_aps_id_chroma | u(3) |
| if( sps_ccalf_enabled_flag ) { | |
| sh_alf_cc_cb_enabled_flag | u(1) |
| if( sh_alf_cc_cb_enabled_flag ) | |
| sh_alf_cc_cb_aps_id | u(3) |
| sh_alf_cc_cr_enabled_flag | u(1) |
| if( sh_alf_cc_cr_enabled_flag ) | |
| sh_alf_cc_cr_aps_id | u(3) |
| } | |
| } | |
| } | |
| if( ph_lmcs_enabled_flag && !sh_picture_header_in_slice_header_flag ) | |
| sh_lmcs_used_flag | u(1) |
| if( ph_explicit_scaling_list_enabled_flag && !sh_picture_header_in_slice_header_flag ) | |
| sh_explicit_scaling_list_used_flag | u(1) |
| if( !pps_rpl_info_in_ph_flag && ( ( nal_unit_type != IDR_W_RADL && | |
| nal_unit_type != IDR_N_LP ) \| \| sps_idr_rpl_present_flag ) ) | |
| ref_pic_lists( ) | |
| if( ( sh_slice_type != I && num_ref_entries[ 0 ][ RplsIdx[ 0 ] ] > 1 ) \| \| | |
| ( sh_slice_type = = B && num_ref_entries[ 1 ][ RplsIdx[ 1 ] ] > 1 ) ) { | |
| sh_num_ref_idx_active_override_flag | u(1) |
| if( sh_num_ref_idx_active_override_flag ) | |
| for( i = 0; i < ( sh_slice_type = = B ? 2: 1 ); i++ ) | |
| if( num_ref_entries[ i ][ RplsIdx[ i ] ] > 1 ) | |
| sh_num_ref_idx_active_minus1[ i ] | ue(v) |
| } | |
| if( sh_slice_type != I ) { | |
| if( pps_cabac_init_present_flag ) | |
| sh_cabac_init_flag | u(1) |
| if( ph_temporal_mvp_enabled_flag && !pps_rpl_info_in_ph_flag ) { | |
| if( sh_slice_type = = B ) | |
| sh_collocated_from_l0_flag | u(1) |
| if( ( sh_collocated from_l0_flag && NumRefIdxActive[ 0 ] > 1 ) \| \| | |
| ( ! sh_collocated_from_l0_flag && NumRefIdxActive[ 1 ] > 1 ) ) | |
| sh_collocated_ref_idx | ue(v) |
| } | |
| if( !pps_wp_info_in_ph_flag && | |
| ( ( pps_weighted_pred_flag && sh_slice_type = = P ) \| \| | |
| ( pps_weighted_bipred_flag && sh_slice_type = = B ) ) ) | |
| pred_weight_table( ) | |
| } | |
| if( !pps_qp_delta_info_in_ph_flag ) | |
| sh_qp_delta | se(v) |
| if( pps_slice_chroma_qp_offsets_present_flag ) { | |
| sh_cb_qp_offset | se(v) |
| sh_cr_qp_offset | se(v) |
| if( sps_joint_cbcr_enabled_flag ) | |
| sh_joint_cbcr_qp_offset | se(v) |
| } | |
| if( pps_cu_chroma_qp_offset_list_enabled_flag ) | |
| sh_cu_chroma_qp_offset_enabled_flag | u(1) |
| if( sps_sao_enabled_flag && !pps_sao_info_in_ph_flag ) { | |
| sh_sao_luma_used_flag | u(1) |
| if( sps_chroma_format_idc != 0 ) | |
| sh_sao_chroma_used_flag | u(1) |
| } | |
| if( pps_deblocking_filter_override_enabled_flag && !pps_dbf_info_in_ph_flag ) | |
| sh_deblocking_params_present_flag | u(1) |
| if( sh_deblocking_params_present_flag ) { | |
| if( !pps_deblocking_filter_disabled_flag ) | |
| sh_deblocking_filter_disabled_flag | u(1) |
| if( !sh_deblocking_filter_disabled_flag ) { | |
| sh_luma_beta_offset_div2 | se(v) |
| sh_luma_tc_offset_div2 | se(v) |
| if( pps_chroma_tool_offsets_present_flag ) { | |
| sh_cb_beta_offset_div2 | se(v) |
| sh_cb_tc_offset_div2 | se(v) |
| sh_cr_beta_offset_div2 | se(v) |
| sh_cr_tc_offset_div2 | se(v) |
| } | |
| } | |
| } | |
| if( sps_dep_quant_enabled_flag ) | |
| sh_dep_quant_used_flag | u(1) |
| if( sps_sign_data_hiding_enabled_flag && !sh_dep_quant_used_flag ) | |
| sh_sign_data_hiding_used_flag | u(1) |
| if( sps_transform_skip_enabled_flag && !sh_dep_quant_used_flag && | |
| !sh_sign_data_hiding_used_flag ) | |
| sh_ts_residual_coding_disabled_flag | u(1) |
| if( pps_slice_header_extension_present_flag ) { | |
| sh_slice_header_extension_length | ue(v) |
| for( i = 0; i < sh_slice_header_extension_length; i++) | |
| sh_slice_header_extension_data_byte[ i ] | u(8) |
| } | |
| if( NumEntryPoints > 0 ) { | |
| sh_entry_offset_len_minus1 | ue(v) |
| for( i = 0; i < NumEntryPoints; i++ ) | |
| sh_entry_point_offset_minus1[ i ] | u(v) |
| } | |
| byte_alignment( ) | |
| } | |

### 2. Video Codec Beyond VVC

ITU-T VCEG (Q6/16) and ISO/IEC MPEG (JTC 1/SC 29/WG 5) are studying the potential need for standardization of future video coding technology with a compression capability that significantly exceeds that of the current VVC standard. The Enhanced Compression Model (ECM) reference software is provided to demonstrate a reference implementation of encoding techniques and the decoding process for JVET Enhanced compression beyond VVC capability exploration work.

ECM basically is the successor to VVC and thus it shares many common parts as VVC.

### 3. Proposed Method

In this invention, several methods are proposed to avoid signaling the bits or reduce the bits to signal the syntax elements in the slice header (SH) and/or picture header (PH).

In the first embodiment, one or more additional syntax element(s) is/are signaled in the VPS, SPS and/or PPS to indicate whether the corresponding syntax element in the SH or PH is signaled or not. When the corresponding syntax element in the SH or PH is signaled, its value is derived according to the signaled value in the SH or PH. When the corresponding syntax element in the SH or PH is not signaled, its value is derived according to the semantic values of the signaled one or more additional syntax element(s) and/or the other syntax elements signaled in the NAL Unit header, VPS, SPS PPS, SH and/or PH. Several examples are illustrated below.

Example 1: one additional syntax element, e.g. dummy (the name could be changed to any other name without affecting its functionality), is signaled in the VPS, SPS and/or PPS to indicate whether the syntax element ph_non_ref_pic_flag is signaled in the associated picture header or not. When dummy is signalled as 1 (or 0), ph_non_ref_pic_flag is not signaled and is inferred as 0 (or 1). When dummy is signaled as 0 (or 1), ph_non_ref_pic_flag is signaled using the existed scheme in the PH and its value is directly derived based on the signaled ph_non_ref_pic_flag. An example of the syntax element signaling and its semantic is illustrated below.

| | |
|---|---|
| if( !dummy ) | |
| ph_non_ref_pic_flag | u(1) |

ph_non_ref_pic_flag equal to 1 specifies that the current picture is never used as a reference picture. ph_non_ref_pic_flag equal to 0 specifies that the current picture might or might not be used as a reference picture. When not present (dummy is equal to 1), the value of ph_non_ref_pic_flag is inferred to be equal to 0.

Example 2-1: one syntax element, e.g. dummy (the name could be changed to any other name without affecting its functionality), is signaled in the VPS, SPS and/or PPS to indicate whether the syntax element ph_gdr_pic_flag is signaled in the associated picture header or not. When dummy is signalled as 1 (or 0), ph_gdr_pic_flag is not signaled and is inferred as 0 (or 1). When dummy is signaled as 0 (or 1), ph_gdr_pic_flag is signaled using the existed scheme in the PH and its value is directly derived based on the signaled ph_gdr_pic_flag. An example of the syntax element signaling and its semantic is illustrated below.

| | |
|---|---|
| if( ph_gdr_or_irap_pic_flag && !dummy ) | |
| ph_gdr_pic_flag | u(1) |

ph_gdr_pic_flag equal to 1 specifies that the current picture is a GDR picture. ph_gdr_pic_flag equal to 0 specifies that the current picture is not a GDR picture. When sps_gdr_enabled_flag is equal to 0, the value of ph_gdr_pic_flag shall be equal to 0. When not present, the value of ph_gdr_pic_flag is inferred to be equal to 0.

NOTE 1—When ph_gdr_or_irap_pic_flag is equal to 1 and ph_gdr_pic_flag is equal to 0, the current picture is an IRAP picture.

Example 2-2: one additional syntax element, e.g. dummy1 (the name could be changed to any other name without affecting its functionality), is signaled in the VPS, SPS and/or PPS to indicate whether the syntax element ph_gdr_pic_flag is signaled in the associated picture header or not. Yet another additional syntax element, e.g. dummy2, is signaled in the VPS, SPS and/or PPS to indicate the value when ph_gdr_pic_flag is not signaled. When dummy 1 is signalled as 1 (or 0), ph_gdr_pic_flag is not signaled and is inferred as dummy2. When dummy1 is signaled as 0 (or 1), ph_gdr_pic_flag is signaled using the existed scheme in the PH and its value is directly derived based on the signaled ph_gdr_pic_flag. An example of the syntax element signaling and its semantic is illustrated below.

| | |
|---|---|
| if( ph_gdr_or_irap_pic_flag && !dummy1 ) | |
| ph_gdr_pic_flag | u(1) |

ph_gdr_pic_flag equal to 1 specifies that the current picture is a GDR picture. ph_gdr_pic_flag equal to 0 specifies that the current picture is not a GDR picture. When sps_gdr_enabled_flag is equal to 0, the value of ph_gdr_pic_flag shall be equal to 0. When not present, the value of ph_gdr_pic_flag is inferred to be equal to dummy2.

NOTE 1—When ph_gdr_or_irap_pic_flag is equal to 1 and ph_gdr_pic_flag is equal to 0, the current picture is an IRAP picture.

Example 3: one syntax element, e.g. dummy (the name could be changed to any other name without affecting its functionality), is signaled in the VPS, SPS and/or PPS to indicate whether the syntax element ph_intra_slice_allowed_flag is signaled in the associated picture header or not. When dummy is signalled as 1 (or 0), ph_intra_slice_allowed_flag is not signaled and is inferred as 1 (or 0, or 1—ph_inter_slice_allowed_flag). When dummy is signaled as 0 (or 1), ph_intra_slice_allowed_flag is signaled using the existed scheme in the PH and its value is directly derived based on the signaled ph_intra_slice_allowed_flag. An example of the syntax element signaling and its semantic is illustrated below.

| | |
|---|---|
| if( ph_inter_slice_allowed_flag && !dummy ) | |
| ph_intra_slice_allowed_flag | u(1) |

ph_intra_slice_allowed_flag equal to 0 specifies that all coded slices of the picture have sh_slice_type equal to 0 or 1. ph_intra_slice_allowed_flag equal to 1 specifies that there might or might not be one or more coded slices in the picture that have sh_slice_type equal to 2. When not present, the value of ph_intra_slice_allowed_flag is inferred to be equal to 1.

NOTE 2—For bitstreams that are supposed to work for subpicture based bitstream merging without the need of changing PH NAL units, the encoder is expected to set the values of both ph_inter_slice_allowed_flag and ph_intra_slice_allowed_flag equal to 1.

Example 4-1: one syntax element, e.g. dummy (the name could be changed to any other name without affecting its functionality), is signaled in the VPS, SPS and/or PPS to indicate whether the syntax element ph_pic_parameter_set_id is signaled in the associated picture header or not. When dummy is signalled as 1 (or 0), ph_pic_parameter_set_id is not signaled and is inferred as 0 (or 1). When dummy is signaled as 0 (or 1), ph_pic_parameter_set_id is signaled using the existed scheme in the PH and its value is directly derived based on the signaled ph_pic_parameter_set_id. An example of the syntax element signaling and its semantic is illustrated below.

| | |
|---|---|
| If(dummy) | |
| ph_pic_parameter_set_id | ue(v) |

ph_pic_parameter_set_id specifies the value of pps_pic_parameter_set_id for the PPS in use. The value of ph_pic_parameter_set_id shall be in the range of 0 to 63, inclusive. When not present, the value of ph_pic_parameter_set_id is inferred to be equal to 0.

It is a requirement of bitstream conformance that the value of TemporalId of the PH shall be greater than or equal to the value of TemporalId of the PPS that has pps_pic_parameter_set_id equal to ph_pic_parameter_set_id.

Example 4-2: two syntax elements, e.g. dummy_min and dummy_max (the name could be changed to any other name without affecting its functionality), are signaled in the VPS, SPS and/or PPS to indicate the range of the syntax element ph_pic_parameter_set_id signaled in the associated picture header. An example of the syntax element signaling and its semantic is illustrated below.

| | |
|---|---|
| ph_pic_parameter_set_id | ue(v) |

When dummy_min is not signaled, it is inferred to be equal to 0.

When dummy_max is not signaled, it is inferred to be equal to 63.

ph_pic_parameter_set_id specifies the value of pps_pic_parameter_set_id for the PPS in use. The value of ph_pic_parameter_set_id shall be in the range of dummy_min to dummy_max, inclusive.

It is a requirement of bitstream conformance that the value of TemporalId of the PH shall be greater than or equal to the value of TemporalId of the PPS that has pps_pic_parameter_set_id equal to ph_pic_parameter_set_id.

Example 5: one syntax element, e.g. dummy (the name could be changed to any other name without affecting its functionality), is signaled in the VPS, SPS and/or PPS to indicate whether the syntax element ph_pic_output_flag is signaled in the associated picture header or not. When dummy is signalled as 1 (or 0), ph_pic_output_flag is not signaled and is inferred as 1 (or 0). When dummy is signaled as 0 (or 1), ph_pic_output_flag is signaled using the existed scheme in the PH and its value is directly derived based on the signaled ph_pic_output_flag. An example of the syntax element signaling and its semantic is illustrated below.

| | |
|---|---|
| if( pps_output_flag_present_flag && !ph_non_ref_pic_flag && dummy) | |
| ph_pic_output_flag | u(1) |

ph_pic_output_flag affects the decoded picture output and removal processes as specified in Annex C. When ph_pic_output_flag is not present, it is inferred to be equal to 1.

It is a requirement of bitstream conformance that the bitstream shall contain at least one picture with pic_output_flag equal to 1 that is in an output layer.

NOTE 5—There is no picture in the bitsteam that has ph_non_ref_pic_flag equal to 1 and ph_pic_output_flag equal to 0.

Example 6: one syntax element, e.g. dummy (the name could be changed to any other name without affecting its functionality), is signaled in the VPS, SPS and/or PPS to indicate whether the syntax element ph_collocated_ref_idx is signaled in the associated picture header or not. When dummy is signalled as 0 (or 1), ph_collocated_ref_idx is not signaled and is inferred as 0. When dummy is signaled as 1 (or 0), ph_collocated_ref_idx is signaled using the existed scheme in the PH and its value is directly derived based on the signaled ph_collocated_ref_idx. An example of the syntax element signaling and its semantic is illustrated below.

| | |
|---|---|
| if( ( dummy&& ph_collocated_from_l0_flag && | |
| num_ref_entries[ 0 ][ RplsIdx[ 0 ] ] > 1 ) \| \| | |
| ( !ph_collocated_from_l0_flag && | |
| num_ref_entries[ 1 ][ RplsIdx[ 1 ] ] > 1 ) ) | |
| ph_collocated_ref_idx | ue(v) |

ph_collocated_ref_idx specifies the reference index of the collocated picture used for temporal motion vector prediction.

When ph_collocated_from_10_flag is equal to 1, ph_collocated_ref_idx refers to an entry in RPL 0, and the value of ph_collocated_ref_idx shall be in the range of 0 to num_ref_entries[0][RplsIdx[0]]−1, inclusive.

When ph_collocated_from_10_flag is equal to 0, ph_collocated_ref_idx refers to an entry in RPL 1, and the value of ph_collocated_ref_idx shall be in the range of 0 to num_ref_entries[1][RplsIdx[1]]−1, inclusive.

When not present, the value of ph_collocated_ref_idx is inferred to be equal to 0.

Example 7: one syntax element, e.g. dummy (the name could be changed to any other name without affecting its functionality), is signaled in the VPS, SPS and/or PPS to indicate whether the syntax element sh_collocated_ref_idx is signaled in the associated picture header (or SH) or not. When dummy is signalled as 0 (or 1), sh_collocated_ref_idx is not signaled and is inferred as 0. When dummy is signaled as 1 (or 0), sh_collocated_ref_idx is signaled using the existed scheme in the PH (or SH) and its value is directly derived based on the signaled sh_collocated_ref_idx. An example of the syntax element signaling and its semantic is illustrated below.

| | |
|---|---|
| if( ( sh_collocated_from_l0_flag && NumRefIdxActive[ 0 ] > 1 ) \| \| | |
| ( ! sh_collocated_from_l0_flag && NumRefIdxActive[ 1 ] > 1 ) ) | |
| sh_collocated_ref_idx | ue(v) |

sh_collocated_ref_idx specifies the reference index of the collocated picture used for temporal motion vector prediction.

When sh_slice_type is equal to P or when sh_slice_type is equal to B and sh_collocated_from_10_flag is equal to 1, sh_collocated_ref_idx refers to an entry in RPL 0, and the value of sh_collocated_ref_idx shall be in the range of 0 to NumRefIdxActive[0]−1, inclusive.

When sh_slice_type is equal to B and sh_collocated_from_10_flag is equal to 0, sh_collocated_ref_idx refers to an entry in RPL 1, and the value of sh_collocated_ref_idx shall be in the range of 0 to NumRefIdxActive[1]−1, inclusive.

When sh_collocated_ref_idx is not present, the following applies:
If pps_rpl_info_in_ph_flag is equal to 1, the value of sh_collocated_ref_idx is inferred to be equal to ph_collocated_ref_idx.
Otherwise (pps_rpl_info_in_ph_flag is equal to 0), the value of sh_collocated_ref_idx is inferred to be equal to 0.

Let colPicList be set equal to sh_collocated_from_10_flag?0:1. It is a requirement of bitstream conformance that the picture referred to by sh_collocated_ref_idx shall be the same for all non-I slices of a coded picture, the value of RprConstraintsActiveFlag[colPicList][sh_collocated_ref_idx] shall be equal to 0, and the value of sps_log2_ctu_size_minus5 for the picture referred to by sh_collocated_ref_idx shall be equal to the value of sps_log2_ctu_size_minus5 for the current picture.

NOTE 2—The collocated picture has the same spatial resolution, the same scaling window offsets, the same number of subpictures, and the same CTU size as the current picture.

Example 8: one syntax element, e.g. dummy (the name could be changed to any other name without affecting its functionality), is signaled in the VPS, SPS and/or PPS to indicate whether the syntax element sh_slice_type is signaled in the associated picture header (or SH) or not. When dummy is signalled as 0 (or 1), sh_slice_type is not signaled and is inferred as 0. When dummy is signaled as 1 (or 0), sh_slice_type is signaled using the existed scheme in the PH (or SH) and its value is directly derived based on the signaled sh_slice_type. An example of the syntax element signaling and its semantic is illustrated below.

| | |
|---|---|
| if( ph_inter_slice_allowed_flag ) | |
| sh_slice_type | ue(v) |

sh_slice_type specifies the coding type of the slice according to Table 7.

TABLE 7
Name association to sh_slice_type

| sh_slice_type | Name of sh_slice_type |
|---|---|
| 0 | B (B slice) |
| 1 | P (P slice) |
| 2 | I (I slice) |

When not present, the value of sh_slice_type is inferred to be equal to 2.

When ph_intra_slice_allowed_flag is equal to 0, the value of sh_slice_type shall be equal to 0 or 1.

When both of the following conditions are true, the value of sh_slice_type shall be equal to 2:
The value of nal_unit_type is in the range of IDR_W_RADL to CRA_NUT, inclusive.
The value of vps_independent_layer_flag[GeneralLayerIdx[nuh_layer_id]] is equal to 1 or the current picture is the first picture in the current AU.

When sps_subpic_treated_as_pic_flag[CurrSubpicIdx] is equal to 0, pps_mixed_nalu_types_in_pic_flag is equal to 1 (i.e., there are at least two subpictures in the current picture having different NAL unit types), the value of sh_slice_type shall be equal to 2.

NOTE 1—This constraint is technically equivalent to the following: “When pps_mixed_nalu_types_in_pic_flag for a picture is equal to 1 (i.e., there are at least two subpictures in a picture having different NAL unit types), the value of sps_subpic_treated_as_pic_flag[ ] shall be equal to 1 for all the subpictures that are in the picture and contain at least one P or B slice.”

Example 9: The coding efficiency of trellis-coded quantization (or termed as dependent quantization) in VVC increased by increasing the number of quantization states (at the cost of a higher encoder complexity). Dependent quantization with 8 quantization states in addition to the current variant of dependent quantization with 4 quantization state is supported (detail could be referred to the JVET document JVET-Q0243). To support both variants of dependent quantization (4 and 8 states) in a unified framework, one syntax element (e.g. sh_dep_quant_idc) is signaled in PH and/or SH to indicate whether 4-states dependent quantization (DQ) or 8-states DQ is used for the current picture, or DQ is off for the current picture.

one syntax element, e.g. dummy (the name could be changed to any other name without affecting its functionality), is signaled in the VPS, SPS and/or PPS to indicate whether the syntax element sh_dep_quant_idc is signaled in the associated picture header (or SH) or not. When dummy is signalled as 0 (or 1), sh_dep_quant_idc is not signaled and is inferred as a value to indicate 8-states DQ (e.g. 2 in ECM6.0). When dummy is signaled as 1 (or 0), sh_dep_quant_idc is signaled using the existed scheme in the PH (or SH) and its value is directly derived based on the signaled sh_dep_quant_idc. An example of the syntax element signaling and its semantic is illustrated below.

| | |
|---|---|
| if( sps_dep_quant_enabled_flag && !dummy ) | |
| sh_dep_quant_idc | u(1) |

sh_dep_quant_idc equal to 0 specifies that dependent quantization is not used for the current slice. sh_dep_quant_idc equal to 1 specifies that dependent quantization is used for the current slice. When sh_dep_quant_idc is not present, the following applies:
If dummy is equal to 1, the value of sh_dep_quant_idc is inferred to be equal to a value to indicate 8-states DQ (e.g. 2 in ECM6.0).
Otherwise (dummy is equal to 0), the value of sh_dep_quant_idc is inferred to be equal to 0.

In ECM, in addition to the conventional bi prediction signal, the multi-hypothesis inter prediction mode (MHP introduced in JVET-M0425) is proposed to utilize one or more additional motion-compensated prediction signals. The resulting overall prediction signal is obtained by sample-wise weighted superposition. With the bi prediction signal p_{bi} and the first additional inter prediction signal/hypothesis h₃, the resulting prediction signal p₃ is obtained as follows:

$${p}_{3} = ( 1 - α ) {p}_{bi} + α {h}_{3}$$

The weighting factor α is specified by the new syntax element add_hyp_weight_idx, according to the following mapping:

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pₙ having the largest index n).

The number of additional prediction signal could be signaled in the sps. Moreover, in the picture level, the number of additional prediction signal could be signaled (e.g. num_ref_idx_addhyp_accitive) to override the signaled number of the additional prediction signal transmitted in sps.

In the second embodiment, when signaling the number of additional prediction signal, the value of the number of additional prediction signal minus one is signaled because the number of additional predictions signaled shall be larger than or equal to one.

In the third embodiment, when signaling the number of additional prediction signal in the SH/PH, the difference between the signaled additional prediction signal in SPS and the number of the additional prediction signal used in current picture coding is signaled. In one example, “the number of additional prediction signal in SPS” minus “the number of the additional prediction signal used in the current picture or slice” is signaled in the PH/SH. At the decoder, when the value is received, the number of the additional prediction signal is reconstructed by adding the received value plus the number of additional prediction signal in SPS.

Any of the foregoing proposed methods could also be applied to but not limited to the other existed syntax element such as “ph_alf_enabled_flag”, “ph_alf_cb_enabled_flag”, “ph_alf_cr_enabled_flag”, “ph_alf_cc_cb_enabled_flag”, “ph_alf_cc_cr_enabled_flag”, “ph_Imcs_enabled_flag”, “ph_collocated_from_10_flag”, “ph_mmvd_fullpel_only_flag”, “ph_mvd_l1_zero_flag”, “ph_joint_cbcr_sign_flag”, “ph_sao_luma_enabled_flag”, “ph_sao_chroma_enabled_flag”, “ph_deblocking_params_present_flag”, “sh_picture_header_in_slice_header_flag”, sh_Imcs_used_flag”, “sh_no_output_of_prior_pics_flag”, “sh_alf_enabled_flag”, “sh_alf_cb_enabled_flag”, “sh_alf_crs_enabled_flag”, “sh_alf_cc_cb_enabled_flag”, “sh_alf_cc_cr_enabled_flag”, “sh_explicit_scaling_list_used_flag”, “sh_sao_luma_used_flag”, “sh_sao_chroma_used_flag”, “sh_dep_quant_used_flag”, “sh_sign_data_hiding_used_flag”, “sh_ts_residual_coding_disabled_flag” and “ph_deblocking_filter_disabled_flag” and so on.

Any of the foregoing proposed methods can be implemented in encoders and/or decoders. For example, any of the proposed methods can be implemented in syntax element coding of an encoder and/or a decoder. Alternatively, any of the proposed methods can be implemented as a circuit coupled to syntax element coding of the encoder and/or the decoder.

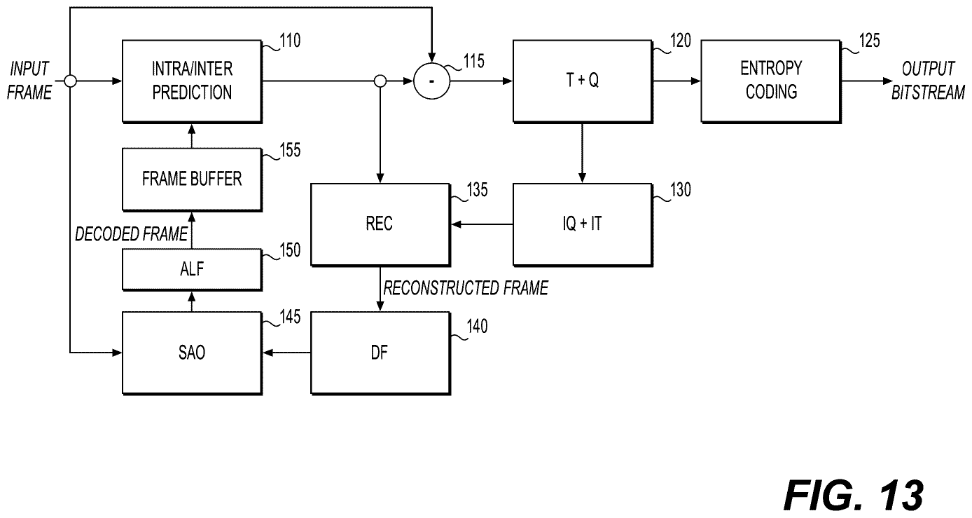

FIG. 13 shows a block diagram of a video encoder that can include or be coupled to a module or circuit implementing the methods and techniques described in the disclosure. The video encoder may be implemented based on the VVC standard, the HEVC standard (with ALF added) or any other video coding standard. The Intra/Inter Prediction unit 110 generates Inter prediction based on Motion Estimation (ME)/Motion Compensation (MC) when Inter mode is used. The Intra/Inter Prediction unit 110 generates Intra prediction when Intra mode is used. The Intra/Inter prediction data (i.e., the Intra/Inter prediction signal) is supplied to the subtractor 115 to form prediction errors, also called “residues” or “residual”, by subtracting the Intra/Inter prediction signal from the signal associated with the input frame. The process of generating the Intra/Inter prediction data is referred as the prediction process in this disclosure. The prediction error (i.e., the residual) is then processed by Transform (T) followed by Quantization (Q) (T+Q, 120). The transformed and quantized residues are then coded by Entropy Coding unit 125 to be included in a video bitstream corresponding to the compressed video data.

The bitstream associated with the transform coefficients is then packed with side information such as motion, coding modes, and other information associated with the image area. The side information may also be compressed by entropy coding to reduce required bandwidth. Since a reconstructed frame may be used as a reference frame for Inter prediction, a reference frame or frames have to be reconstructed at the encoder end as well. Consequently, the transformed and quantized residues are processed by Inverse Quantization (IQ) and Inverse Transformation (IT) (IQ+IT, 130) to recover the residues. The reconstructed residues are then added back to Intra/Inter prediction data at Reconstruction unit (REC) 135 to reconstruct video data. The process of adding the reconstructed residual to the Intra/Inter prediction signal is referred as the reconstruction process in this disclosure. The output frame from the reconstruction process is referred as the reconstructed frame.

In order to reduce artefacts in the reconstructed frame, in-loop filters, including but not limited to, Deblocking Filter (DF) 140, Sample Adaptive Offset (SAO) 145, and Adaptive Loop Filter (ALF) 150 are used. In this disclosure, DF, SAO, and ALF are all labeled as a filtering process. The filtered reconstructed frame at the output of all filtering processes is referred as a decoded frame in this disclosure. The decoded frames are stored in Frame Buffer 155 and used for prediction of other frames.

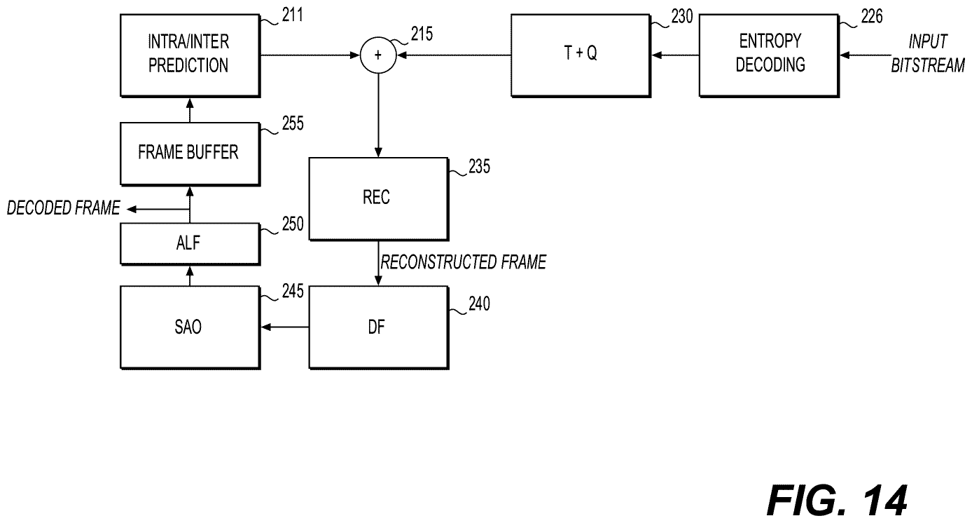

FIG. 14 shows a block diagram of a video decoder that can include or be coupled to a module or circuit implementing the methods and techniques described in the disclosure. The video decoder may be implemented based on the VVC standard, the HEVC standard (with ALF added) or any other video coding standard. Since the encoder contains a local decoder for reconstructing the video data, many decoder components are already used in the encoder except for the entropy decoder. At the decoder side, an Entropy Decoding unit 226 is used to recover coded symbols or syntaxes from the bitstream. The process of generating the reconstructed residual from the input bitstream is referred as a residual decoding process in this disclosure. The prediction process for generating the Intra/Inter prediction data is also applied at the decoder side, however, the Intra/Inter prediction unit 211 is different from the Intra/Inter prediction unit 110 in the encoder side since the Inter prediction only needs to perform motion compensation using motion information derived from the bitstream. Furthermore, an Adder 215 is used to add the reconstructed residues to the Intra/Inter prediction data.

Those skilled in the art will also understand that there can be many variations made to the operations of the techniques explained above while still achieving the same objectives of the disclosure. Such variations are intended to be covered by the scope of this disclosure. As such, the foregoing descriptions of embodiments of the disclosure are not intended to be limiting. Rather, any limitations to embodiments of the disclosure are presented in the following claims.

What is claimed is:

1. A method for video decoding in a video decoder, comprising:
receiving a first syntax element from a video parameter set (VPS), a sequence parameter set (SPS), or a picture parameter set (PPS) in a bitstream, the first syntax element indicating whether a second syntax element is signaled in a slice header (SH) or a picture header (PH) of a current picture;
in response to the first syntax element having a first value indicating that the second syntax element is not signaled in the SH or the PH, deriving a value of the second syntax element based on values of at least one of the first syntax element and one or more third syntax elements in a network abstraction layer (NAL) unit header, the VPS, the SPS, the PPS, the SH, or the PH; and
in response to the first syntax element having a second value indicating that the second syntax element is signaled in the SH or the PH, deriving the value of the second syntax element based on the second syntax element signaled in the SH or PH.

2. The method of claim 1, wherein the second syntax element is a syntax element in the PH, and
when the first syntax element has the first value, the derived value of the second syntax element is determined as a value indicating that a picture associated with the PH may or may not be used as a reference picture.

3. The method of claim 1, wherein the second syntax element is a syntax element in the PH, and
when the first syntax element has the first value, the derived value of the second syntax element is determined as
a value indicating that a picture associated with the PH is not a gradual decoding refresh (GDR) picture, or
a value of a third syntax elements, where the third syntax element is received in the VPS, the SPS, or the PPS.

4. The method of claim 1, wherein the second syntax element is a syntax element in the PH, and
when the first syntax element has the first value, the derived value of the second syntax element is determined as a value specifying that there may or may not be one or more coded slices in a picture associated with the PH that are I slices.

5. The method of claim 1, wherein the second syntax element is a syntax element in the PH, and
when the first syntax element has the first value, the derived value of the second syntax element is determined as 0, which specifies that a picture associated with the PH is associated with a picture parameter set having an ID equal to 0.

6. The method of claim 1, wherein the second syntax element is a syntax element in the PH, and
when the first syntax element has the first value, the derived value of the second syntax element is determined as a value specifying that a picture associated with the PH is in an output layer.

7. The method of claim 1, wherein the second syntax element is a syntax element in the PH, and
when the first syntax element has the first value, the derived value of the second syntax element is determined as a value specifying that a reference index of a collocated picture used for temporal motion vector prediction of a picture associated with the PH is 0.

8. The method of claim 1, wherein the second syntax element is a syntax element in the PH or SH, and
when the first syntax element has the first value, the derived value of the second syntax element is determined as a value specifying that a reference index of a collocated picture used for temporal motion vector prediction of a slice associated with the PH or the SH is 0.

9. The method of claim 1, wherein the second syntax element is a syntax element in the PH or SH, and
when the first syntax element has the first value, the derived value of the second syntax element is determined as
a value specifying that a slice associated with the PH or the SH is a B slice, or
a value determined based on a value of a third syntax element, where the third syntax element specifies whether an inter slice is allowed or not for coding the picture associated with the PH or the SH.

10. The method of claim 1, wherein the second syntax element is a syntax element in the PH or SH, and
when the first syntax element has the first value, the derived value of the second syntax element is determined as
a value indicating that 8-state dependent quantization is used in a slice associated with the PH or the SH, or
a value of a third syntax element, where the third syntax element is received in the VPS, the SPS, or the PPS.

11. The method of claim 1, wherein the second syntax element is a syntax element in the PH,
when the first syntax element has the first value, the derived value of the second syntax element is determined based on a value of the third syntax element, where the third syntax element specifying whether a picture associated with the PH is an Instantaneous Decoder Refresh (IDR) picture or not.

12. A method for video encoding in a video encoder, comprising:
signaling a first syntax element in a video parameter set (VPS), a sequence parameter set (SPS), or a picture parameter set (PPS) in a bitstream, the first syntax element indicating whether a second syntax element is signaled in a slice header (SH) or a picture header (PH), or left for a decoder to derive based on values of at least one of the first syntax element and one or more third syntax elements in a network abstraction layer (NAL) unit header, the VPS, the SPS, the PPS, the SH, or the PH;
in response to the first syntax element having a first value indicating that the second syntax element is left for the decoder to derive, avoiding signaling the second syntax element in the SH or the PH; and
in response to the first syntax element having a second value indicating that the second syntax element is signaled in the SH or the PH, signaling the second syntax element in the SH or the PH.

13. The method of claim 12, wherein the second syntax element is a syntax element in the PH, and
when a picture associated with the PH may or may not be used as a reference picture, the first syntax element is signaled with the first value.

14. The method of claim 12, wherein the second syntax element is a syntax element in the PH, and
when a picture associated with the PH is not a gradual decoding refresh (GDR) picture,
the first syntax element is signaled with the first value, or
the first syntax element is signaled with the first value, and a third syntax element is signaled to specify whether the picture associated with the PH is a GDR picture or not.

15. The method of claim 12, wherein the second syntax element is a syntax element in the PH, and
when there may or may not be one or more coded slices in a picture associated with the PH that are I slices, the first syntax element is signaled with the first value.

16. The method of claim 12, wherein the second syntax element is a syntax element in the PH, and
when a picture associated with the PH is associated with a Picture Parameter Set (PPS) having an ID equal to 0, the first syntax element is signaled with the first value.

17. The method of claim 12, wherein the second syntax element is a syntax element in the PH, and
when a picture associated with the PH is in an output layer, the first syntax element is signaled with the first value.

18. The method of claim 12, wherein the second syntax element is a syntax element in the PH, and
when a reference index of a collocated picture used for temporal motion vector prediction of a picture associated with the PH is 0, the first syntax element is signaled with the first value.

19. The method of claim 12, wherein the second syntax element is a syntax element in the PH or SH, and
when a reference index of a collocated picture used for temporal motion vector prediction of a slice associated with the PH or the SH is 0, the first syntax element is signaled with the first value.

20. A method for video decoding in a video decoder, comprising:
in response to receiving a first syntax element from a video parameter set (VPS), a sequence parameter set (SPS), or a picture parameter set (PPS) in a bitstream, determining that a lower limit of a value range for a third syntax element in a picture header (PH) of a current picture is a value of the received first syntax element, where a value of the third syntax element specifies an ID of a picture parameter set associated with the current picture;
in response to not receiving the first syntax element from the VPS, the SPS, or the PPS, determining that the lower limit of the value range for the third syntax element is 0;
in response to receiving a second syntax element from the VPS, the SPS, or the PPS, determining that an upper limit of the value range for the third syntax element is a value of the received second syntax element; and
in response to not receiving the second syntax element from the VPS, the SPS, or the PPS, determining that the upper limit of the value range for the third syntax element is 63.
